(19) United States
(12) Patent Application Publication
(10) Pub. No.: US 2025/0371104 A1
(43) Pub. Date: Dec. 4, 2025

(54) HYBRID SPECULATIVE DECODING SYSTEM WITH MODELS ON SILICON

(71) Applicant: Intel Corporation, Santa Clara, CA (US)

(72) Inventors: Yaron Klein, Rosh Haayin (IL); Yoni Elron, Hadera (IL); John Crouter, Fair Oaks, CA (US); Yuval Vered, Tel-Aviv (IL); Guy Boudoukh, Ramat Hasharon (IL)

(73) Assignee: Intel Corporation, Santa Clara, CA (US)

(21) Appl. No.: 19/300,222

(22) Filed: Aug. 14, 2025

Related U.S. Application Data
(60) Provisional application No. 63/721,841, filed on Nov. 18, 2024.

(51) Int. Cl. G06F 17/16; G06N 3/063

(52) U.S. Cl. CPC G06F 17/16; G06N 3/063

(57) ABSTRACT

A speculative decoding system may include integrated circuits (ICs), a router, and a processing unit. The ICs may implement different models that can perform different types of tasks. The router may route an input prompt, which may include one or more input tokens, to an IC based on the task to be performed using the input prompt. The IC may include hardware implementations of operators in a model. The IC may generate speculative token(s) from the input prompt by running the operators in the model. The speculative token(s) may be drafted to the processing unit. The processing unit may validate the speculative token(s) and generate output token(s) by executing another model, which may be larger than the model executed by the IC. The processing unit may validate multiple speculative tokens in parallel. Key-value pairs generated by the IC may be used by the processing unit for executing the other model.

### CROSS-REFERENCE TO RELATED APPLICATION

This application claims the benefit of U.S. Provisional Patent Application No. 63/721,841, filed Nov. 18, 2024, and titled “HYBRID SPECULATIVE DECODING SYSTEM UTILIZING MODEL ON SILICON EMBEDDED EXPERT MODELS FOR NEURAL NETWORK MODELS,” which is incorporated by reference in its entirety for all purposes.

### TECHNICAL FIELD

This disclosure relates generally to artificial intelligence (AI), and more specifically, hybrid speculative decoding systems with models on silicon.

### BACKGROUND

Neural networks (also referred to as “deep neural networks” or “DNNs”) are used extensively for a variety of Al applications ranging from natural language processing to computer vision, speech recognition, and image processing due to their ability to achieve high accuracy. However, the high accuracy comes at the expense of significant computation cost. DNNs have extremely high computing demands as there can be a large number of operations as well as a large amount of data to read and write. Therefore, techniques to improve efficiency of DNNs are needed.

### BRIEF DESCRIPTION OF THE DRAWINGS

Embodiments can be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates autoregressive decoding, in accordance with various embodiments.

FIG. 2 illustrates speculative decoding, in accordance with various embodiments.

FIG. 3 illustrates hybrid speculative decoding, in accordance with various embodiments.

FIG. 4 is a block diagram of a speculative decoding system, in accordance with various embodiments.

FIG. 5 illustrates a speculative decoding process, in accordance with various embodiments.

FIG. 6 illustrates a speculative decoding system, in accordance with various embodiments.

FIG. 7 is a flowchart of a method of speculative decoding, in accordance with various embodiments.

FIG. 8 illustrates an example transformer model, in accordance with various embodiments.

FIG. 9A and 9B illustrate inferences of a transformer model, in accordance with various embodiments.

FIG. 10 is a block diagram of a neural processing unit (NPU), in accordance with various embodiments.

FIG. 11 illustrates an integrated circuit (IC) device that implements a model on silicon, in accordance with various embodiments.

FIG. 12 is a block diagram of an example computing device, in accordance with various embodiments.

### DETAILED DESCRIPTION

The last decade has witnessed a rapid rise in AI based data processing, particularly based on neural networks (also referred to as deep neural networks (DNNs)). DNNs are widely used in various domains (e.g., language processing, computer vision, speech recognition, autonomous driving, image processing, video processing, etc.) mainly due to their ability to achieve beyond human-level accuracy. A DNN typically includes a sequence of layers. A DNN layer may include one or more deep learning operations (also referred to as “neural network operations”), such as embedding operation, matrix multiplication (MatMul), layer normalization, batch normalization, activator operations (e.g., Sigmoid linear unit (SILU) operation, SoftMax operation, etc.) pooling, elementwise operation, linear operation, nonlinear operation, and so on.

DNNs, such as LLMs, often require substantial computational resources and time, especially when generating and validating tokens sequentially. The deployment and execution of DNN models, especially complex models, are predominantly carried out on high-performance graphic processing units (GPUs). While GPUs can provide the computational horsepower needed to handle these sophisticated models, they typically come with significant drawbacks, including high power consumption and latency issues. These limitations become especially problematic in environments where real-time processing and power efficiency are critical, such as in mobile devices, edge computing, and Internet of Things (IoT) applications.

To address these challenges, speculative decoding can be used to accelerate inference in DNNs, such as large language models (LLMs). Speculative decoding usually involves running multiple models in parallel, where smaller models generate potential next tokens, and a larger model validates these predictions. While speculative decoding offers a promising method to improve inference speed in many DNNs, it still necessitates the use of high-value resources to run both the smaller and larger models concurrently. The challenge lies in balancing the computational demands between the smaller and larger models to achieve optimized performance, power efficiency, and accuracy in AI tasks.

Many currently available conventional approaches involve using standard GPUs where model weights are loaded from memory every time an inference task is performed. While GPUs offer flexibility, allowing them to handle a wide range of tasks, this comes at the cost of optimization, power consumption, and latency. This process consumes significant power and time, particularly for complex models. GPUs are designed to handle diverse tasks, making them inefficient for dedicated tasks like inference on a pretrained model alone.

NPUs are typically specialized hardware designed explicitly for AI tasks, particularly inference on pretrained models. They are optimized for the types of computations required in deep learning, such as matrix multiplications and convolutions, and can handle large-scale model weights more efficiently than general-purpose hardware. Although NPUs provide significant improvements over GPUs in terms of efficiency for deep learning tasks, they still face challenges related to power consumption and latency. Moreover, their flexibility to handle various deep learning models can sometimes be a drawback when it comes to optimization for specific tasks.

Embodiments of this disclosure may improve on at least some of the challenges and issues described above by providing a hybrid speculative decoding system that includes a combination of general-purpose hardware (e.g., GPU or NPU) for larger models and specialized hardware for smaller models. Specialized hardware includes IC devices (e.g., dies or chips) specialized in running particular models. Such an IC device is referred to as a model on silicon. Smaller models may be designed to run on specialized hardware, ensuring they operate incredibly fast and efficiently. Each small model may specialize in predicting certain types of tokens, allowing for a more targeted and optimized prediction process. By offloading as much processing as possible to these specialized chips, the high-value compute resources (e.g., GPUs or NPUs) can be optimized for performance, power efficiency, and speed. Smaller models may generate speculative tokens and Key-Value (KV) pairs, which are then passed to the larger model. The larger, target model may run on an NPU or GPU and focus on refining and validating these predictions. The validation step can be parallelized, allowing for simultaneous likelihood computations for multiple tokens, significantly speeding up the process. This hybrid approach is an optimization of token prediction in LLMs to improve speed, power efficiency, and overall system performance.

In various embodiments, a system for speculative decoding may include IC devices, a routing module, a drafting module, and a processing unit. The IC devices may be models on silicon. The IC devices may implement different DNN models that specialize in performing different types of tasks. The routing module may be another model on silicon that implements a routing model. The routing module may route an input prompt, which may include one or more input tokens, to one of IC devices (e.g., the most approximate one of the IC devices) based on the task to be performed using the input prompt. The IC device may include hardware implementations of operators in a corresponding model. For instance, the operators in the model may be mapped to various compute units in the IC device. The IC device may generate speculative token(s) from the input prompt by running the operators in the corresponding model. The drafting module may draft the speculative token(s) from the IC device to the processing unit. The processing unit may validate the speculative token(s) and generate output token(s) by executing the target model, which may be larger than the model executed by the IC device. The model executed by the processing unit may be a larger model. The processing unit may validate multiple speculative tokens in parallel. The system may also include a shared memory. KV pairs generated by the IC device may be stored in the shared memory. The processing unit may read the KV pairs from the shared memory and use the KV pairs to run the target model.

This hybrid approach can provide a balanced solution by offloading initial speculative predictions to smaller models that can operate on specialized hardware, thereby optimizing the usage of GPU or NPU for final validation and refinement of predictions. This hybrid approach not only accelerates the inference process but also enhances power efficiency and overall system performance. By utilizing smaller models for speculative token generation, the computational load on the larger model can be reduced, allowing the larger model to focus on refining and validating the predictions. This parallelized validation process can leverage state-of-the-art hardware's ability to handle multiple forward passes simultaneously, further speeding up the overall computation.

The approach in this disclosure involves embedding multiple small expert models onto silicon chips, each tailored to different aspects of token prediction, to enhance speculative decoding in LLMs. This approach leverages a mixture of experts paradigm where the presentation of the next tokens is routed to the most suitable small model, thereby optimizing the utilization of GPU or NPU and accelerating token prediction. The small models embedded on silicon chips are designed to run incredibly fast and efficiently thanks to their specialized hardware. These small chips can act as companions to the large model that runs on a high-value compute resource like GPU or NPU. The large model is allowed to focus on refining and validating the predictions, thereby improving the overall accuracy and efficiency of the LLM. The validation step can be parallelized. This means that the likelihood computation for each token (or group of tokens) happens simultaneously rather than sequentially. GPUs and NPUs can handle multiple forward passes at the same time, significantly speeding up the validation process.

By offloading as much processing as possible to these small chips, the usage of the high-value compute resource can be optimized. This hybrid approach can also eliminate unnecessary data transfers and ensures rapid processing, providing a substantial performance boost. Further, by leveraging specialized hardware for speculative decoding, this approach can minimize power consumption. The small expert models embedded on silicon offload significant processing from the GPU or NPU, which reduces the need for repeated memory access operations. This can result in lower power usage, making the system more power-efficient and environmentally friendly. Moreover, the use of dedicated model on silicon for running small expert models tailored for speculative decoding makes this approach more cost-effective. Therefore, the overall system performance, power efficiency, and speed in AI tasks can be enhanced.

For purposes of explanation, specific numbers, materials and configurations are set forth in order to provide a thorough understanding of the illustrative implementations. However, it can be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A or B” or the phrase “A and/or B” means (A), (B), or (A and B). For the purposes of the present disclosure, the phrase “A, B, or C” or the phrase “A, B, and/or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations are described using terms commonly employed by those skilled in the art to convey the substance of their work to others skilled in the art.

The terms “substantially,” “close,” “approximately,” “near,” and “about,” generally refer to being within +/−20% of a target value as described herein or as known in the art. Similarly, terms indicating orientation of various elements, e.g., “coplanar,” “perpendicular,” “orthogonal,” “parallel,” or any other angle between the elements, generally refer to being within +/−5-20% of a target value as described herein or as known in the art.

In addition, the terms “comprise,” “comprising,” “include,” “including,” “have,” “having” or any other variation thereof, are intended to cover a non-exclusive inclusion. For example, a method, process, device, or DNN accelerator that comprises a list of elements is not necessarily limited to only those elements but may include other elements not expressly listed or inherent to such method, process, device, or DNN accelerators. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

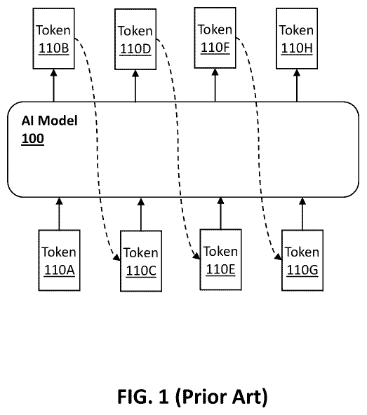

FIG. 1 illustrates autoregressive decoding, in accordance with various embodiments. For the purpose of illustration, FIG. 1 shows an AI model 100. The AI model 100 may be a DNN model that has been trained to perform one or more AI tasks, such as language processing speech recognition, computer vision, and so on. In an example, the DNN model may be a transformer-based model, such as an LLM.

The AI model 100 receives a token 110A. The token 110A is also referred to as an input token. In other embodiments, the AI model 100 may receive multiple input tokens at a time. The receipt of the token 110A may trigger inference of the AI model 100 for performing an Al task, such as task of text generation, image classification, machine translation, text summarization, language translation, question answering, code generation, image or audio generations, and so on. In the example shown in FIG. 1, the AI model 100 generates tokens 110B-110H from the token 110A. The tokens 110B-110H may be generated through a plurality of inference processes. These inference processes may be performed sequentially. Each inference process may include an execution of the AI model 100 to generate a new token. An inference process may also be referred to as an inference stage.

In an example, the first inference process may have the token 110A as an input and generate the token 110B as an output; the second inference process may have the token 110A and token 110B as an input and generate the token 110C as an output; the third inference process may have the tokens 110A-110C as an input and generate the token 110D as an output; the fourth inference process may have the tokens 110A-110D as an input and generate the token 110E as an output; the fifth inference process may have the tokens 110A-110E as an input and generate the token 110F as an output; the sixth inference process may have the tokens 110A-110F as an input and generate the token 110G as an output; and the seventh inference process may have the tokens 110A-110G as an input and generate the token 110H as an output.

Autoregressive models, like the AI model 100, can generate sequences one token at a time, with each token dependent on the previously generated tokens. This method can ensure high accuracy but can be slow due to its sequential nature, making it less efficient for large-scale tasks.

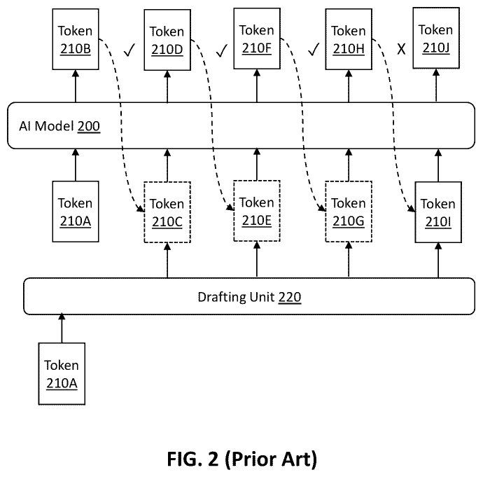

FIG. 2 illustrates speculative decoding, in accordance with various embodiments. For the purpose of illustration, FIG. 2 shows an AI model 200. The AI model 200 may be a DNN model that has been trained to perform one or more AI tasks, such as language processing speech recognition, computer vision, and so on. In an example, the DNN model may be a transformer-based model, such as an LLM. The AI model 200 may be an example of the AI model 100 in FIG. 1. In the embodiments of FIG. 2, a token 210A is used as an input to generate tokens 210B-2101 through speculative decoding as opposed to autoregressive decoding. Speculative decoding seeks to improve the efficiency of autoregressive decoding by generating multiple tokens in parallel.

The speculative decoding process has two steps. In the first step, a drafting unit 220 performs an initial draft of speculative tokens, which may be created quickly, providing a rough approximation of the sequence. In the example shown in FIG. 2, the speculative, drafted tokens include token 210C, token 210E, token 210G, and token 210I. The speculative, drafted tokens are generated by one or more models that may be smaller than the AI model 200. In some embodiments, these tokens may be generated by a smaller model through autoregressive decoding. As the model is smaller, the autoregressive decoding is more efficient and consumes less computation resources than the autoregressive decoding of the AI model 200.

In the second step, the drafted tokens are verified to ensure they meet the standards of the AI model 200. For instance, the token 210A is input into the AI model 200 for the first inference process to generate the token 210B. Then the tokens 210A-210C are input into the AI model 200 for the second inference process to generate the token 210D. The accuracy of the token 210D may be verified to ensure it meets the accuracy requirement or standard of the AI model 200. For instance, it may be determined whether an accuracy score or confidence score of the token 210D is above a threshold score. In the example shown in FIG. 2, it is determined that the token 210D is accurate (which is indicated by the checkmark next to the token 210D in FIG. 2) so that the token 210C, which is a speculative token, is validated as an accurate output token. Similarly, the tokens 210A-210E are input into the AI model 200 for the third inference process to generate the token 210F indicated by the checkmark next to the token 210F in FIG. 2, and the token 210E, which is a speculative token, is validated. Then, the tokens 210A-210G are input into the AI model 200 for the fourth inference process to generate the token 210H, and the token 210G, which is a speculative token, is validated. Next, the tokens 210A-210I are input into the AI model 200 for the fifth inference process to generate the token 210J. It is determined that the accuracy of the token 210J does not meet the requirement indicated by the X mark next to the token 210J in FIG. 2. For instance, the accuracy score or confidence score of the token 210J is below a threshold score. Therefore, the token 210I, which is a speculative token, is invalidated. The validated tokens (i.e., tokens 210C, 210E, and 210G) may be included in the final output. In some embodiments, the AI model 200 may generate one or more additional tokens to be included in the final output.

The speculative decoding process in FIG. 2 can generate an output with tokens 210B-210H through four inference stages, while the autoregressive decoding process needs seven inference stages. Thus, the speculative decoding process in FIG. 2 is more efficient compared with the autoregressive decoding process in FIG. 1. In some embodiments, the drafted tokens are then verified in parallel to ensure they meet the model's standards, further improving the efficiency while maintaining accuracy.

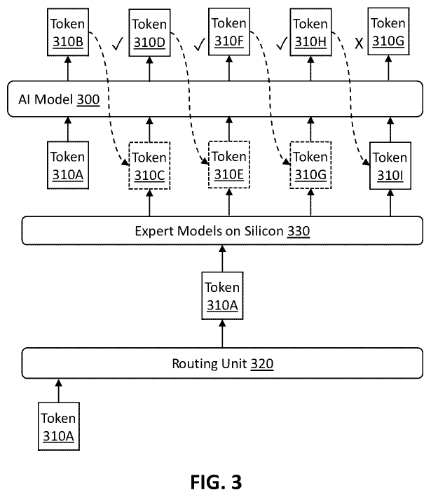

FIG. 3 illustrates hybrid speculative decoding, in accordance with various embodiments. The speculative decoding in FIG. 3 may be an example of the speculative decoding in FIG. 2. For the purpose of illustration, FIG. 3 shows an AI model 300. The AI model 300 may be a DNN model that has been trained to perform one or more AI tasks, such as language processing speech recognition, computer vision, and so on. In an example, the DNN model may be a transformer-based model, such as an LLM. The AI model 300 may be an example of the AI model 100 in FIG. 1 or the AI model 200 in FIG. 2. In the embodiments of FIG. 3, a token 310A is used as an input to generate tokens 310B-310I through speculative decoding.

FIG. 3 also shows a routing unit 320, which routes input tokens to the expert models on silicon 330. The expert models on silicon 330 may be hardware implementations of DNN models that have been trained for performing various AI tasks. These DNN models are referred to as expert models as they are specialized in the AI tasks for which they are trained. In some embodiments, different ones of these models may be specialized in different AI tasks. An expert model on silicon may be an IC device (e.g., a die or chip) that implements an expert model. The IC device includes compute units that can be mapped to different operators in the expert model. In the example where the token 310A is received, the routing unit 320 may determine the nature of the AI task to be performed using the token 310A and directs the token 310A to the most appropriate one of the expert models on silicon 330. The expert model on silicon receiving the token 310A generates the tokens 310C, 310E, 310G, and 310I as speculative tokens. The speculative tokens are provided to the AI model 300 for validity evaluation, similar to the validity evaluation described above in conjunction with FIG. 2.

The expert models in FIG. 3 can leverage specialized hardware (silicon) to further enhance the speculative decoding process. The use of silicon-based expert systems can optimize both speed and performance, making this method superior in handling complex and large-scale tasks. While traditional autoregressive decoding focuses on sequential token generation, speculative decoding introduces parallelism to enhance speed. The expert models on silicon can take this a step further by integrating specialized hardware and expert routing, offering significant improvements in efficiency and accuracy.

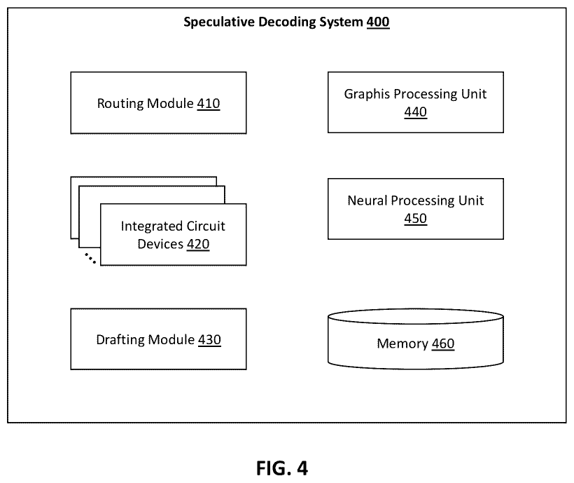

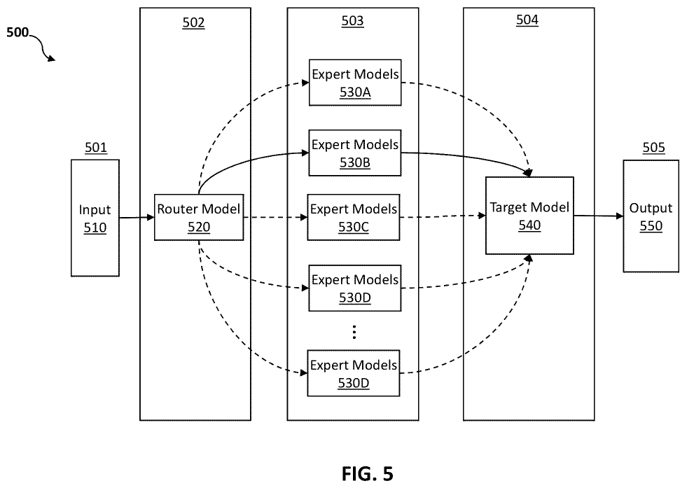

FIG. 4 is a block diagram of a speculative decoding system 400, in accordance with various embodiments. The speculative decoding system 400 is a hybrid compute system with heterogenous hardware. The speculative decoding system 400 can carry out speculative decoding processes to perform AI tasks, including the speculative decoding process described above in conjunction with FIG. 3 and the speculative decoding process described below in conjunction with FIG. 5. As shown in FIG. 4, the speculative decoding system 400 includes a routing module 410, IC devices 420 (individually referred to as “IC device 420”), a drafting module 430, a GPU 440, a NPU 450, and a memory 460. In other embodiments, alternative configurations, different or additional components may be included in the speculative decoding system 400. For instance, the speculative decoding system 400 may include multiple GPUs, NPUs, or memories. Also, the speculative decoding system 400 may include other types of processing units, such as central processing units. Further, functionality attributed to a component of the speculative decoding system 400 may be accomplished by a different component included in the speculative decoding system 400 or a different system. The speculative decoding system 400 may also be referred to as an AI system or AI device. In an example, the speculative decoding system 400 may be an AI server or AI personal computer.

The routing module 410 routes inputs received by the speculative decoding system 400 to the IC devices 420. An input may be a prompt provided by a user or may be generated from a prompt provided by a user. An input may include one or more tokens. In some embodiments, an input may include text, audio, image, video, other types of data, or some combination thereof. In some embodiments, the routing module 410 is an IC device that implements a model that has been trained for routing inputs to the IC devices 420. The model may be referred to as a router or router model, which may be a DNN. The routing module 410 may be a hardware implementation of the model in the speculative decoding system 400. For instance, the routing module 410 may be a die or chip, and the model may be embedded on the die or chip.

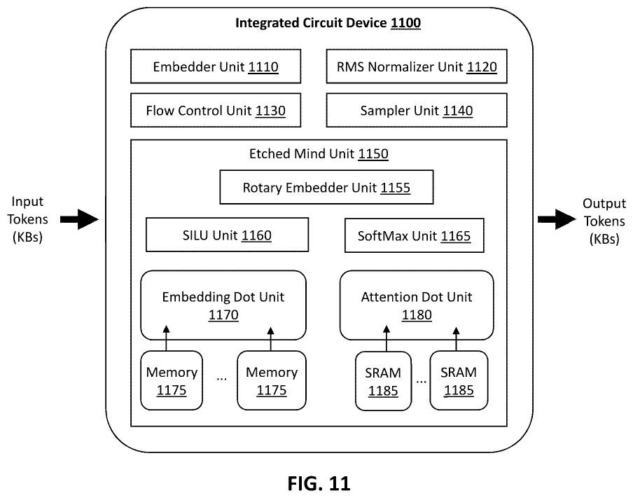

The IC devices 420 implement models specialized in performing various types of AI tasks. These models may be referred to as experts or expert models. The various types of AI tasks may include tasks of text generation, image classification, machine translation, text summarization, language translation, question answering, code generation, image or audio generations, and so on. In some embodiments, each IC device 420 is a model on silicon. An expert model may be a transformer-based model, such as an LLM or other types of transformer-based models. An expert model may include a sequence of layers. A layer may include one or more operators, such as MatMul operators, add operators, activation function operators, pooling operators, and so on. The operators may be mapped to components (such as compute units) of the IC device 420. For instance, each type of operator in the expert model may be mapped to a particular compute unit in the IC device 420. After an IC device 420 receives an input from the routing module 410, the IC device 420 may perform one or more inferences processes of the corresponding expert model. Speculative tokens and KV pairs may be generated through the inference process(es). Certain aspects of the IC devices 420 are described below in conjunction with FIG. 11.

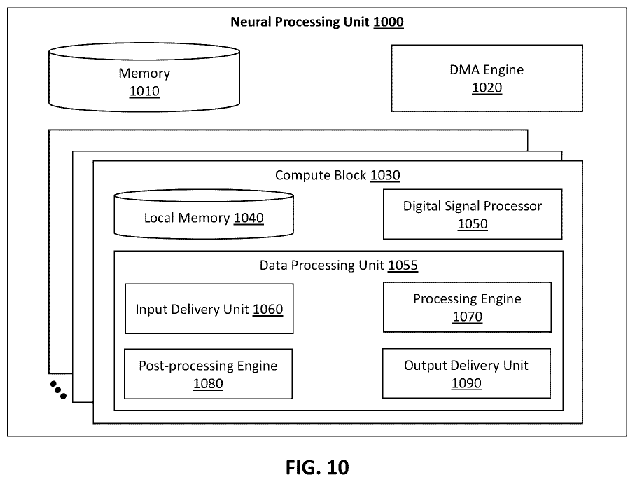

The drafting module 430 drafts speculative tokens generated by the IC device 420 to the GPU 440 or NPU 450. For instance, the drafting module 430 may retrieve the speculative tokens from one or more data storage units of the IC device 420 and transfer the speculative tokens to a data storage unit of the GPU 440 or NPU 450. The drafting module 430 may draft multiple speculative tokens from an IC device 420. These speculative tokens may be generated in different layers or different inference processes of the expert model that is embedded onto the IC device 420. In some embodiments, the drafting module 430 may also draft the input received by the speculative decoding system 400 to the GPU 440 or NPU 450. The GPU 440 or NPU 450 may use the drafted token(s) to run a target model and generate a final output for the AI task. The target model may be a model that has been trained to perform one or more AI tasks, such as the AI tasks in which the expert models are specialized. The target model may be larger than the expert models. In some embodiments, the target model may include more layers than an expert model. For instance, the expert model may include a subset of the layers in the target model. The final layer of the expert model may be an intermediate layer of the target model. Inference of the target model requires more computational resources than inference of the expert model. The GPU 440 or NPU 450 may have the required computational resources. Certain aspects of the NPU 450 are described below in conjunction with FIG. 10.

In some embodiments, the target model may be used to evaluate validity of the speculative tokens. A speculative token may be validated by the target model when a new token generated by the target model using the speculative token meets the accuracy requirement or standard of the target model or of the AI task. In an example, an accuracy score or confidence score may be determined and compared with a threshold score. When the accuracy score or confidence score is above the threshold score, the speculative token is validated; otherwise, the speculative token is invalidated. The final result of the AI task may include validated speculative token(s). In some embodiments, the final result may also include new tokens generated by the target model.

The memory 460 stores data received and generated by the other components of the speculative decoding system 400. In some embodiments, the memory 460 includes a dynamic random-access memories (DRAM). In some embodiments, the memory 460 is accessible by the IC device 420, GPU 440 and NPU 450. The IC device 420 may store data (e.g., KV pairs) into the memory 460. The GPU 440 or NPU 450 may read the KV pairs from the memory 460 and use the KV pairs for generating the final result of the AI task.

FIG. 5 illustrates a speculative decoding process 500, in accordance with various embodiments. The speculative decoding process 500 involves an input 510, a router model 520, expert models 530A-N (collectively referred to as “expert models 530” or “expert model 530”), a target model 540, and an output 550. In other embodiments, the speculative decoding process 500 may involve multiple input tokens or multiple output tokens. Also, fewer, less, or different models may be used to perform the speculative decoding process 500.

The speculative decoding process 500 may be a process for performing an AI task based on the input 510. The input 510 may be the starting point of the AI task. The speculative decoding process 500 may start with receiving the input 510 in Step 501. The input 510 may be a prompt received from a user or generated from a prompt received from a user. The input 510 may include one or more tokens. Tokens in the input 510 are referred to as input tokens. In some embodiments, the input 510 may be text, audio, image, video, other types of signal, or some combination thereof.

The input 510 is provided to the router model 520. In Step 502, the router model 520 routes the input 510 to the most approximate expert model. The router model 520 may be a specialized model, such as a DNN. The router model 520 may be trained for routing inputs to appropriate ones of the expert models 530 to perform AI tasks. For instance, the router model 520 may determine the nature of the input 510 or determine the nature of the AI task to be performed. The router model 520 may make the determination based on the input 510 or other information, then select an expert model 530 based on the determination. In some embodiments, the router model 520 is implemented on hardware. For instance, the router model 520 is a model on silicon. The operators in the router model 520 may be mapped to components of an IC device (e.g., a chip or die) that implements the router model 520. The router model 520 can efficiently direct the input 510 to the most appropriate expert model 530 in Step 502, reducing computational overhead and improving accuracy.

The expert models 530 are machine learning models (e.g., DNNs) that have been trained for performing various tasks, such as machine translation, text generation, text summarization, question answering, code generation, and so on. Each expert model 530 is referred to as an expert. Each expert model 530 may be implemented on a separate IC device, such as a separate die or separate chip. In some embodiments, multiple expert models 530 or even all the expert models 530 may be implemented on the same IC device. Different expert model 530 may be specialized in different tasks. For instance, the expert model 530A may be specialized in machine translation, the expert model 530B may be specialized in text generation, the expert model 530C may be specialized in text summarization, the expert model 530D may be specialized in question answering, . . . , and the expert model 530N may be specialized in code generation. In other embodiments, there may be a different number of experts. The specialized models can ensure that each type of task can be handled by the most capable system.

In an example, the input 510 may be “The weather today is”. The router model 520 may identify that the input 510 likely pertains to text generation and therefore, routes the input 510 to the expert model 530B, which has been trained for performing text generation tasks. The router model 520 may determine that the nature of the task is text generate based on the input 510 and selects the expert model 530B, which is a text generate model (e.g., an LLM), based on the determined nature of the task.

In Step 503, the expert model 530B may generate speculative tokens and KV pairs that represent potential continuations or outputs for the input 510. In the example described above, the expert model 530B may generate speculative tokens like “sunny”, “cloudy”, “rainy”, etc., as possible completions for “The weather today is. The expert model 530B can provide multiple potential outputs, increasing the likelihood of generating a correct or high-quality result. The KV pairs may be stored as a KV cache that can be accessed by the target model 540.

In Step 504, speculative tokens and KV pairs generated in Step 503 may be validated against the target model 540. The target model 540 may be executed by more powerful computation resources, such as GPU or NPU. The validation can ensure that the speculative tokens are correct and consistent. For instance, the validation ensures that the speculative outputs are accurate and consistent with the input 510, leveraging more powerful computational resources when needed. The target model 540 may be larger than the expert model 530B. For instance, the target model 540 may have more layers or more internal parameters than the expert model 530B. It may consume more time and computational resources to execute the target model 540 than the expert model 530B.

In the example above, the target model 540 may evaluate the speculative tokens “sunny”, “cloudy”, “rainy”, etc., to determine which is the most likely or appropriate continuation of “The weather today is”. In this example, the target model 540 may find that “is sunny, with” is valid which saved the full feed forward network having to construct that.

In Step 505, the output 550 is generated from the target model 540. The output 550 may represent the result of the AI task. The output 550 includes one or more output tokens. In some embodiments, the output 550 includes one or more speculative tokens that are generated in Step 503 and validated in Step 504. Additionally or alternatively, the output 550 may include one or more tokens generated by the target model 540 in Step 504. In the example described above, the system might output “is sunny after validation, with a few scattered clouds” as the completion, resulting in the final text “The weather today is sunny, with a few scattered clouds”. The final text is an example of the output 550. The output 550 may be final, user-facing result of the process. For instance, the output 550 may be provided to the user in a user interface, which may be the same inference through which the user provided the input 510.

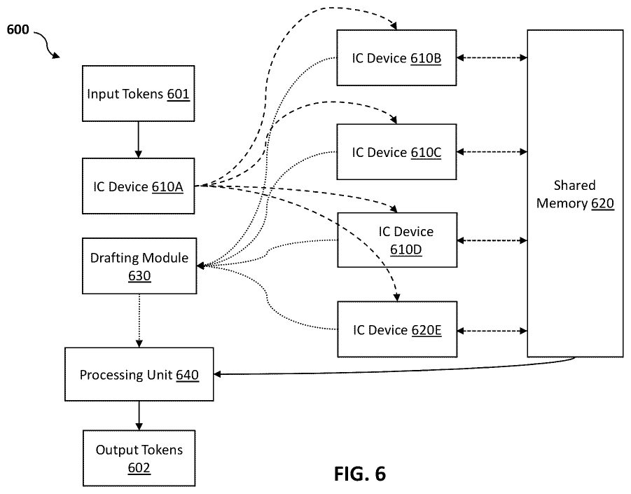

FIG. 6 illustrates a speculative decoding system 600, in accordance with various embodiments. The speculative decoding system 600 may be an example of the speculative decoding system 400 in FIG. 4. The speculative decoding system 600 may perform speculative decoding processes, such as the speculative decoding process 500 in FIG. 5, to perform AI tasks. As shown in FIG. 6, the speculative decoding system 600 includes IC devices 610A-610E (collectively referred to as “IC devices 610” or “IC device 610”), a shared memory 620, a drafting module 630, and a processing unit. In other embodiments, the speculative decoding system 600 may include fewer, more, or different components. Further, functionality attributed to a component of the speculative decoding system 600 may be accomplished by a different component included in the speculative decoding system 600 or a different system.

Each IC device 610 may be a silicon chip or part of a silicon chip. In some embodiments, the IC devices 610 are models on silicon. For instance, the IC device 610 may be a router model on silicon, such as the router model 520. The IC devices 610B-610E may be expert models on silicon, such as the expert models 530. Each IC device 610 may include units that implement operators in the corresponding model. For instance, an IC device 610 may include a dot unit that implements one or more MatMul operators in the model, an activator unit that implements one or more activation functions in the model, an embedding unit that implements one or more embedders in the model, and so on. In some embodiments, each of the IC devices 610B-610E may be a specialized processing unit designed to perform specific tasks or computations. The IC devices 610B-610E can work to provide diverse processing perspectives or speculative outputs.

The IC device 610A distributes inputs to the speculative decoding system 600 to the IC devices 610B-610E. For example, the speculative decoding system 600 receives input tokens 601 from a user, and the IC device 610A executes the router model implemented on the IC device 610A to route the input tokens 601 to an IC device 610 selected from the IC devices 610B-610E. The selected IC device 610 receives the input tokens 601 from the IC device 610A and executes the model implemented on the selected IC device 610 to generate speculative tokens and KV pairs. The selected IC device 610 stores the KV pairs in the shared memory 620. The shared memory 620 is shared by the IC devices 610B-610E and the processing unit 640. In some embodiments, the shared memory 620 is a DRAM. The shared memory 620 may serve as a common storage space where the IC devices 610B-610E can write their computed results (e.g., KV pairs or speculative tokens) and from which the processing unit 640 can read these results. The shared memory 620 can facilitate efficient data sharing between the IC devices 610B-610E and the processing unit 640, reducing redundant computations and saving processing time.

The drafting module 630 drafts the speculative tokens generated by the selected IC device 610 and forwards the speculative tokens to the processing unit 640. The processing unit 640 may read the KV pairs generated by the selected IC device 610 from the drafting module 630. The processing unit 640 may execute a target model using the input tokens 601 and the KV pairs to validate the speculative tokens generated by the selected IC device 610. For instance, the processing unit 640 may verify the accuracy of each speculative token. In some embodiments, a speculative token with an accuracy score above a threshold score may be validated as an accurate token, while a speculative token with an accuracy score below the threshold score may be invalidated. Validated token(s) may be included in the final output of the speculative decoding system 600, which is output tokens 602. The output tokens 602 may also include one or more new tokens generated by the processing unit 640 from executing the target model. The processing unit 640 may generate a new token based on the input tokens 601, one or more speculative tokens that have been validated, or a combination of both. The output tokens 602 may be provided to the user.

The approach of speculative decoding with models on silicon can leverage the concept of embedding multiple small expert models onto silicon chips, each tailored to different aspects of token prediction. This approach can adopt a mixture of experts paradigm, where each small expert model is dedicated to predicting specific types of tokens. These small models can be embedded in specialized hardware to ensure high speed and efficiency, working in conjunction with a larger, more resource-intensive model running on NPUs or GPUs.

By utilizing a mixture of expert models on silicon, this approach can achieve better context handling and predictive accuracy while significantly reducing the computational load on larger models. This approach can offer a superior method for speculative decoding in LLMs, combining the strengths of specialized hardware and advanced AI architectures for optimized performance.

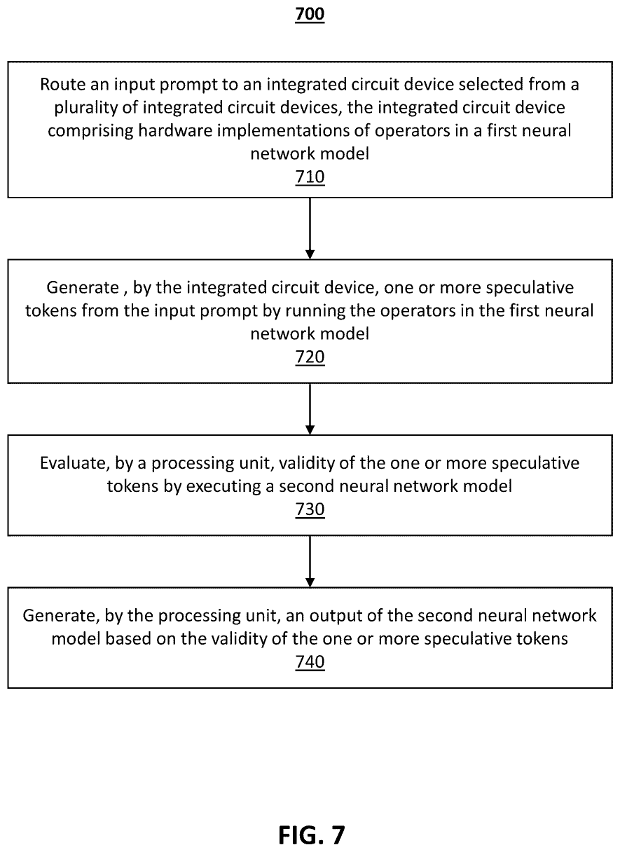

FIG. 7 is a flowchart of a method 700 of speculative decoding, in accordance with various embodiments. The method 700 may be performed by the speculative decoding system 400 in FIG. 4. Although the method 700 is described with reference to the flowchart illustrated in FIG. 7, many other methods for speculative decoding may alternatively be used. For example, the order of execution of the steps in FIG. 7 may be changed. As another example, some of the steps may be changed, eliminated, or combined.

The speculative decoding system 400 routes 710 an input prompt to an IC device selected from a plurality of IC devices. The IC device comprises hardware implementations of operators in a first DNN model. In some embodiments, different ones of the plurality of IC devices are specific to different DNN models that are trained for performing different types of tasks.

The speculative decoding system 400 generates 720, by the IC device, one or more speculative tokens from the input prompt by running the operators in the first DNN model. In some embodiments, the one or more speculative tokens comprises a plurality of speculative tokens, and the speculative decoding system 400 generates the plurality of speculative tokens sequentially.

The speculative decoding system 400 evaluates 730, by a processing unit, validity of the one or more speculative tokens by executing a second DNN model. In some embodiments, the speculative decoding system 400 evaluates validity of a speculative token by verifying whether the speculative token is accurate based on the input prompt. In some embodiments, the one or more speculative tokens comprises a plurality of speculative tokens, and the speculative decoding system 400 evaluates validity of the plurality of speculative tokens in parallel.

The speculative decoding system 400 generates 740, by the processing unit, an output of the second DNN model based on the validity of the one or more speculative tokens. In some embodiments, the output of the second DNN model comprises a speculative token that is validated by the processing unit. In some embodiments, the speculative decoding system 400 stores, in a memory, one or more KV pairs generated by the IC device by executing the first DNN model. The processing unit generates the output of the second DNN model further based on the one or more KV pairs.

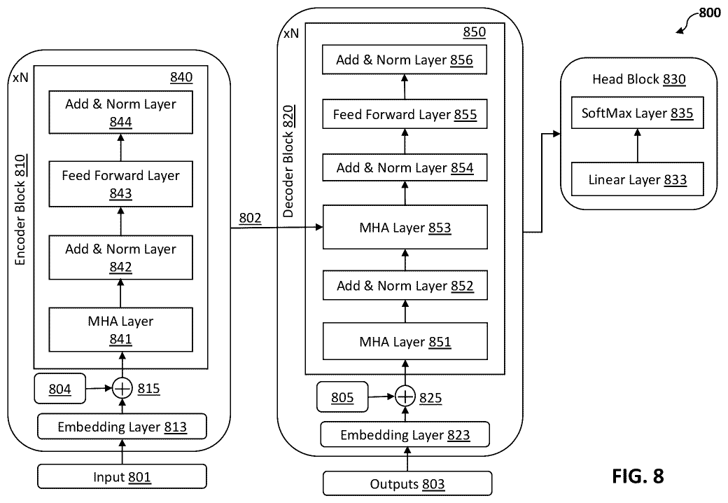

FIG. 8 illustrates an example transformer model 800, in accordance with various embodiments. The transformer model 800 may transform input sequences into output sequences. In some embodiments, the transformer model 800 is a DNN that can learn context and meaning by tracking relationships in sequential data, such as sequential words in a sentence, sequential audio signals, sequential images, and so on. In an example, the transformer model 800 may be at least part of an LLM. The transformer model 800 may be an example of the expert models or target models described above. As shown in FIG. 8, the transformer model 800 includes an encoder block 810, a decoder block 820, and a head block 830. In other embodiment, different or additional components may be included in the transformer model 800. Further, functionality attributed to a component of the transformer model 800 may be accomplished by a different component included in the transformer model 800 or a different model or module.

The encoder block 810 receives input sequences and generates matrix representations of the input sequences. In the embodiments of FIG. 8, the encoder block 810 receives an input 801 and generates an encoder output 802. The input 801 may be an input prompt. In some embodiments, the input 801 may include one or more input tokens, such as words, phrases, sentences, images, audio signals, other types of input tokens, or some combination thereof. In an example, the input 801 may include a prompt received from a user of the transformer model 800. The prompt may include a question or request made by the user. A word in the prompt may be an input token. The encoder output 802 may include one or more vectors that are contextualized representations of the input 801. Each vector in the encoder output 802 may represent a token in the input 801 with contextual understanding.

The encoder block 810 includes an embedding layer 813, a positional encoding layer 815, and a plurality of layers 840 (individually referred to as “layer 840”). In other embodiments, the encoder block 810 may have different, fewer, or more components. Also, the arrangement of the components in the encoder block 810 may be different from the arrangement shown in FIG. 8. For the purpose of illustration, the encoder block 810 has N layers in FIG. 8, where N is an integer. Each layer 840 may include one or more neural network operations. The layers 840 may transform a sequence of embeddings into a representation that encapsulates the learned information from the input 801. Different layers 840 may have different internal parameters, e.g., different weights, bias, or other types of internal parameters. In some embodiments, the layers 840 have identical components. The components in a layer 840 may be layers and may also be referred to as sub-layers of the layer 840. As shown in FIG. 8, a layer 840 includes four sub-layers: a multi-head attention (MHA) layer 841, an add & norm layer 842, a feed forward layer 843, and another add & norm layer 844.

The decoder block 820 iteratively generates outputs 803 using encoded representations generated by the encoder block 810. The decoder block 820 includes an embedding layer 823, a positional encoding layer 825, and a plurality of layers 850 (individually referred to as “layer 850”). For the purpose of illustration, the decoder block 820 has N layers in FIG. 8, where N is an integer. In the embodiments of FIG. 2, the number of layers 850 in the decoder block 820 is the same as the number of layers 840 in the encoder block 810. In other embodiments, the number of layers 850 in the decoder block 820 may be different from the number of layers 840 in the encoder block 810. Each layer 850 may include one or more neural network operations. Different layers 850 may have different internal parameters. In some embodiments, the layers 850 may have identical components. The components in a layer 850 may be layers and may also be referred to as sub-layers of the layer 850. As shown in FIG. 8, a layer 850 includes six sub-layers: an MHA layer 851, an add & norm layer 852, another MHA layer 853, another add & norm layer 854, a feed forward layer 855, and another add & norm layer 856.

In some embodiments, a sequence of inference stages is performed in the decoder block 820 using encoder outputs, e.g., the encoder output 802. A matrix may be predicted through each inference stage. The outputs 803 may include a plurality of matrices. Each matrix may be further processed in the head block 830 to predict a token. The plurality of matrices may be used to predict a sequence of tokens. For the first inference stage, the decoder block 820 may receive one or more start tokens as input tokens and compute a first matrix from the input tokens and the output of the encoder block 810. The first matrix may be used by the head block 830 to predict a first token. The predicted token may be used as a new input token, in addition to the start token(s), in the second inference stage. Similarly, a second token may be predicted through the second inference stage and may be used in the third inference stage. This iteration may continue till all the inference stages are complete.

The head block 830 receives the output of the decoder block 820 and processes it in a linear layer 833 and a SoftMax layer 835. A linear operation may be performed on the output of the decoder block 820 in the linear layer 833. The linear operation may include a multiplication of the output of the decoder block 820 with a weight matrix. The output of the linear layer 833 may be a vector. In some embodiments, the head block 830 may function as a classifier. The number of data elements in the vector computed in the linear layer 833 may depend on the number of classes involved. In an example where there are M classes, where M is an integer, the vector computed in the linear layer 833 may have M data elements representing the prediction for the M classes, respectively.

The output of the linear layer 833 may be input into the SoftMax layer 835. A SoftMax function may be applied on the output of the linear layer 833 to compute probability scores. A probability score may have a value in the range from 0 to 8. In some embodiments, a probability value is computed for each data element in the vector computed in the linear layer 833. The highest one of the probability scores may be the key. The corresponding index of the key may point to the token that the transformer model 800 predicts as the next in the sequence. The final output of the transformer model 800 may be the sequence of predicted tokens. In some embodiments, the head block 830 may be a language modeling head.

An embedding layer (e.g., the embedding layer 813 or the embedding layer 823) converts an input of the embedding layer (e.g., the input 801 or the outputs 803) into one or more embeddings. An embedding may be a vector, which is also referred to as an embedding vector or a vector embedding. The vector embedding may include a sequence of data elements. In some embodiments, the embedding layer 813 may generate a plurality of embeddings, each of which may be converted from a different input token in the input 801. The embeddings may capture the semantic meaning of the tokens in the input 801. The embeddings may be numerical representations that capture the relationships or meanings of words, phrases, or other data types. In an example where the input 801 is a prompt including a sequence of words, the embedding layer 813 may generate an embedding from each word in the input 801. The embedding layer 823 in the decoder block 820 may generate a plurality of embeddings from tokens received by the decoder block 820 in a similar manner as the embedding layer 813.

A positional encoding layer (e.g., the positional encoding layer 815 or the positional encoding layer 825) performs positional encoding on embeddings generated in the corresponding embedding layer. In some embodiments, the positional encoding layer may apply one or more positional encoding vectors (e.g., a positional encoding vector 804 or positional encoding vector 805) on vector embeddings from the corresponding embedding layer to generate new vector embeddings that represent the embeddings with positional context. The positional encoding vector may encode information about the position of the embedding in a sequence of embeddings. In some embodiments, the positional encoding layer performs an addition operation on a positional encoding vector and a vector embedding. The addition operation may be elementwise addition. The positional encoding layer may output an embedding matrix that includes the vector embeddings computed in the positional encoding layer.

An MHA layer (e.g., the MHA layer 841, the MHA layer 851, or the MHA layer 853) may implement a multi-head attention mechanism, which may be a multi-head self-attention mechanism or a multi-head cross-attention mechanism. In some embodiments, the MHA layer 841 or the MHA layer 851 may implement a self-attention mechanism. For self-attention, the queries, keys, and values may come from the same place. For instance, for the MHA layer 841, the queries, keys, and values may all come from the positional encoding layer 815. For the MHA layer 851, the queries, keys, and values may all come from the positional encoding layer 825. The self-attention mechanism may enable the transformer model 800 to relate each token with other tokens. The MHA layer may compute attention scores from embeddings generated in the corresponding positional encoding layer. In some embodiments, the MHA layer may receive one or more queries, one or more keys, and one or more values. In some embodiments, the MHA layer has a number of heads that receive different linearly projected versions of the queries, keys, and values and produce outputs in parallel that are then used to generate the final result.

In some embodiments, the queries, keys, and values input into the MHA layer 841 may be computed from vector embeddings generated by the positional encoding layer 815. The queries, keys, and values input into the MHA layer 851 may be computed from vector embeddings generated by the positional encoding layer 825. A query, key, or value may be a vector the represents a token in a sequence. In some embodiments, a query matrix Q ∈ [symbol] may be computed by multiply an embedding matrix X ∈ [symbol] (e.g., an embedding matrix computed in a positional encoding layer) with a weight matrix W_{q} ∈ [symbol] , where d is the dimension of a vector embedding, N is the number of vector embeddings in the embedding matrix, and h is the number of attention heads. Each row in the query matrix may be a query. A key matrix K ∈ [symbol] may be computed by multiple an embedding matrix X ∈ [symbol] (e.g., an embedding matrix computed in a positional encoding layer) with a weight matrix Wₖ ∈ [symbol] . Each row in the key matrix may be a key. A value matrix V ∈ [symbol] may be computed by multiple an embedding matrix X ∈ [symbol] (e.g., an embedding matrix computed in a positional encoding layer) with a weight matrix Wᵥ ∈ [symbol] . Each row in the value matrix may be a value.

In some embodiments, the MHA layer 851 may implement masked multi-head self-attention. The MHA layer 851 may prevent positions from attending to subsequent positions. For instance, each token in the sequence may not be influenced by future tokens. This masking can ensure that the predictions of a particular position can depend on known outputs at positions before it and not depend on unknown outputs at positions after it.

In some embodiments, the MHA layer 853 may implement a cross-attention mechanism, such as encoder-decoder cross-attention. The MHA layer 853 may use outputs from the previous layer (i.e., the add & norm layer 852) as queries and use outputs from the encoder block 810 as keys and values. The cross-attention can align the encoder's input with the decoder's, empowering the decoder block 820 to identify and emphasize the most relevant parts of the encoder's input.

In some embodiments, an MHA layer includes linear layers, a MatMul layer, a scale layer, a SoftMax layer, another MatMul layer, a concatenation layer, and another linear layer. These layers may be arranged in a sequence. The MHA layer may receive three input matrices: a query matrix, a key matrix, and a value matrix, which are inputs of three linear layers, respectively. The linear layers may include matrix multiplication (MatMul) operations. For instance, a first linear layer may perform a multiplication of the query matrix with a weight matrix to compute a first parameter matrix. The first parameter matrix may be denoted as

$${QW}_{i}^{Q} ,$$

where (is the query matrix and

$${W}_{i}^{Q}$$

∈ [symbol] is the weight matrix. A second linear layer may perform a multiplication of the key matrix with a weight matrix to compute a second parameter matrix. The second parameter matrix may be denoted as

$${KW}_{i}^{K} ,$$

where K is the key matrix and Wᵢ^{K} ∈ [symbol] is the weight matrix. A third linear layer may perform a multiplication of the value matrix with a weight matrix to compute a third parameter matrix. The third parameter matrix may be denoted as

$${VW}_{i}^{V} ,$$

where V is the value matrix and

$${W}_{i}^{V}$$

∈ [symbol] is the weight matrix. i may indicate the index of the head. d_{q} is the dimension of a query vector. dₖ is the dimension of a key vector. dᵥ is the dimension of a value vector. In some embodiments, d_{q}=dₖ=dᵥ=d_{model}/h. In some embodiments, the linear layers may be in a linear block of the MHA layer. In some embodiments, the MHA layer may include multiple linear blocks. For instance, the MHA layer includes h linear blocks. The linear blocks may have the same layers as each other. Each linear block may compute three parameter matrices from the query matrix, key matrix, and value matrix, respectively.

The MatMul layer, scale layer, mask layer, SoftMax layer, and MatMul layer may be in an attention block of the MHA layer. The attention block may implement a scaled dot-product attention mechanism. In some embodiments, the MHA layer includes a plurality of attention blocks that includes the attention block. For the purpose of illustration, the MHA layer includes h attention blocks. The attention blocks may have the same layers as each other. A linear block and an attention block may constitute a head of the MHA layer. When the MHA layer has h linear blocks and h attention blocks, the MHA layer has h heads. A head may be denoted as

$${head}_{i} = Attention ( {QW}_{i}^{Q} , {KW}_{i}^{K} , {VW}_{i}^{V} ) .$$

A matrix multiplication operation may be performed on parameter matrices in the MatMul layer, which computes a score matrix. In some embodiments, the score matrix may establish the degree of emphasis each token should place on other tokens. The score matrix may include a plurality of scores. Each token may be assigned a score in relation to other tokens within the same time step. A higher score may indicate a higher focus or emphasis. The score matrix may be scaled in the scale layer. In some embodiments, the score matrix is scaled down in the scale layer by dividing the scores in the score matrix by the square root of the dimension of the query vector and the key vector, which may be denoted as \sqrt{dₖ}. The output of the scale layer may be a scaled matrix, which includes adjusted scores. The mask layer may be optional in some embodiments. The mask layer may add an attention mask (which may be an input to the attention block) to the output of the scale layer to mask out some elements in the output of the scale layer. The positions of the masked-out elements may be defined by the attention mask. A SoftMax function may be applied on the scaled matrix in the SoftMax layer to compute an attention weight matrix. The attention weight matrix includes attention weights. The attention weights may be probability values ranging from 0 to 1. The SoftMax function may emphasize high scores while diminishing low scores, which can enhance the model's ability to determine which tokens should get more attention.

In the MatMul layer, a matrix multiplication operation is performed on the attention weight matrix computed in the SoftMax layer and the parameter matrix computed from value matrix in the corresponding linear layer. The result of the matrix multiplication operation is a single-head output matrix, which is an output of the attention block.

When the MHA layer has h attention blocks, there may be h single-head output matrices. The single-head output matrices are concatenated in the concatenation layer to form a concatenated matrix. A linear operation (also referred to as “linear transformation”) is performed on the concatenated matrix using a weight matrix in the linear layer. In some embodiments, the MHA may be denoted as MultiHead(Q, K, V)=Concat (head₁, head₂, . . . , headₙ)W^{O}, where Concat denotes concatenation, and W^{O} ∈ [symbol] is the weight matrix in the corresponding linear layer.

An add & norm layer in the transformer model 800, such as the add & norm layer 842, 844, 852, 854, and 856, has an addition operation followed by a layer normalization operation. The addition operation may be an addition of the output of the preceding layer and the input of the preceding layer. The preceding layer is a layer that is arranged right before the add & norm layer. For example, the preceding layer of the add & norm layer 842 is the MHA layer 841. As another example, the preceding layer of the add & norm layer 854 is the MHA layer 853.

Then the layer normalization operation is applied on the result of the addition operation, which may be denoted as LayerNorm(x+sublayer(x)), where LayerNorm denotes layer normalization, x is the input of the preceding layer, and sublayer(x) denotes the output of the preceding layer. In some embodiments, the layer normalization operation may include a sequence of computations. In an example, the layer normalization operation may include a mean computation, which may be denoted as

$${μ}_{xy} = \frac{1}{z} \times {\sum }_{z = 1}^{Z} {A}_{xyz} ,$$

where A_{xyz} denotes a data element in the input tensor, x may be the positional index of the data element in one of the spatial dimensions, y may be the positional index of the data element in the other one of the spatial dimensions, z may be the positional index of the data element in the channel dimension, and μ_{xy} denotes the output of the mean computation, which may be a 2D matrix. The mean computation may be channel-wise reduction operation. The layer normalization operation may convert μ_{xy} to a 3D tensor μ_{xyz}, e.g., by replicating every data element over z output points.

The layer normalization operation may also include an elementwise subtraction, which may be denoted as D_{xyz}=A_{xyz}−μ_{xyz}. The layer normalization operation may further include a variance computation denoted as

$${σ}_{xy}^{2} = {\sum }_{z = 1}^{Z} {D}_{xyz}^{2}$$

and a division computation denoted as

$${M}_{xy} = \frac{1}{\sqrt{\frac{1}{Z} \times ( {σ}_{xy}^{2} + ϵ \times Z )}} .$$

M_{xy} may be a 2D tensor. The layer normalization operation may also convert M_{xy} to a 3D tensor M_{xyz}, e.g., by replicating every data element over z output points. Further, the layer normalization operation may have an element multiplication denoted as

$${A}_{xyz}^{′} = \frac{{A}_{xyz} - {μ}_{xyz}}{\sqrt{\frac{1}{Z} \times ( {σ}_{xy}^{2} + ϵ )}} = ( {A}_{xyz} - {μ}_{xyz} ) \times \frac{1}{\sqrt{\frac{1}{Z} \times ( {σ}_{xy}^{2} + ϵ )}} = {D}_{xyz} \times {M}_{xyz} .$$

The layer normalization operation may further compute

$${A}_{xyz}^{″} = {A}_{xyz}^{′} + \frac{{β}_{Z}}{{γ}_{Z}} and {LN}_{xyz} = {A}_{xyz}^{″} \times {γ}_{Z} \cdot {LN}_{xyz}$$

may be the output of the layer normalization operation.

A feed forward layer (e.g., the feed forward layer 843 and the feed forward layer 855) may be a position-wise fully-connected feed forward network. In an example, the feed forward layer may include two linear layers with an activation function in between. An example of the activation function is Rectified Linear Unit (ReLU).

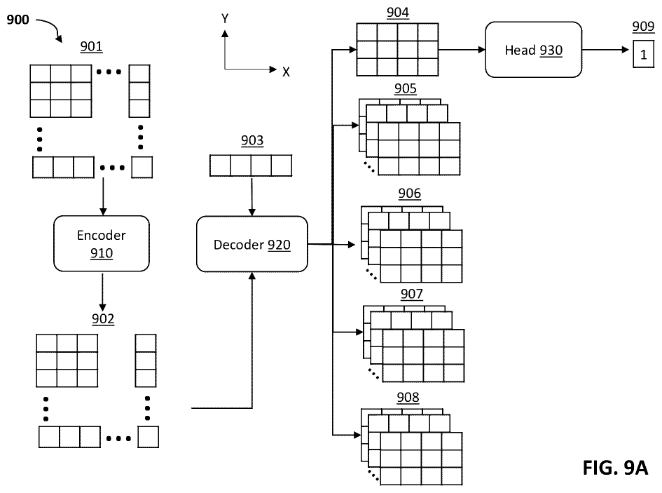

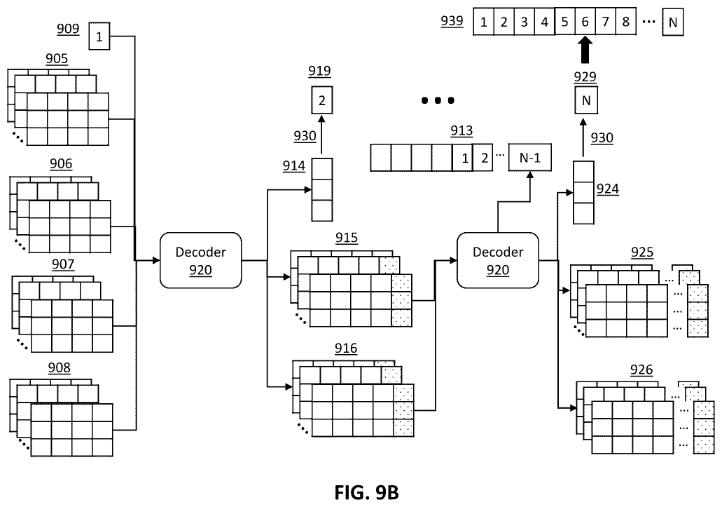

FIG. 9A and 9B illustrate inferences of a transformer model 900, in accordance with various embodiments. FIG. 9A illustrates the first inference process of the transformer model 900, in accordance with various embodiments. The transformer model 900 includes an encoder 910, a decoder 920, and a head 930. An example of the transformer model 900 may be the transformer model 800 in FIG. 8. In the embodiments of FIG. 9A, the encoder 910 receives an input tensor 901. The input tensor 901 may be a feature map extracted from one or more images, text documents, audio files, videos, other types of data, or some combination thereof. The encoder 910 generates an output tensor 902 from the input tensor 901. The shape of the output tensor 902 may be denoted as [batch size,SL_{encoder},d_{model}], where SL_{encoder} may be the dimension along the X axis (i.e., the width of the output tensor 902), and d_{model} may be the dimension along the Y axis (i.e., the height of the output tensor 902). The encoder 910 may include a plurality of layers arranged in a sequence, such as the layers inside the encoder block 810 in FIG. 8. The output tensor 902 is provided to the decoder 920.

The decoder 920 receives the output tensor 902 and an input sequence 903. The input sequence 903 may be a sequence of tokens. A token may be a numerical representation of an input signal, such as word, image, audio signal, video signal, etc. The dimension of the input sequence 903, which may be denoted as SLᵢₙₚᵤₜ, may be the total number of tokens in the input sequence 903. For the purpose of illustration and simplicity, SLᵢₙₚᵤₜ is 4. In other embodiments, the input sequence 903 may have a different shape. For instance, the input sequence 903 may be a 2D tensor. The dimension of the 2D tensor along the X axis may be SLᵢₙₚᵤₜ, while the dimension of the 2D tensor along the Y axis may be a batch size indicating the number of batches in the input sequence 903.

The decoder 920 computes an output tensor 904, a self-attention key tensor 905, a self-attention value tensor 906, a cross-attention key tensor 907, and a cross-attention value tensor 908. In some embodiments, the shape of the output tensor 904 may be denoted as [batch size,SLᵢₙₚᵤₜ,d_{model}]. The shape of the self-attention key tensor 905 or the shape of the self-attention value tensor 906 may be denoted as N×[batch size,h,SLᵢₙₚᵤₜ,d_{head}], where N is the number of identical layers in the decoder (e.g., the number of layers 850 in the decoder block 820), h is the total number of heads in a MHA layer, and d_{head} is the dimension of a query vector, key vector, or value vector. In some embodiments, d_{model}=h×d_{head}. The shape of the cross-attention key tensor 907 or the shape of the cross-attention value tensor 908 may be denoted as N×[batch size,h,SL_{encoder},d_{head}].

The output tensor 904 may be provided to the head 930 and the head 930 outputs a predicted token 909. The shape of the token 909 may be denoted as [batch size, 1]. For the purpose of illustration and simplicity, batch size is 1 in FIG. 9A. In other embodiments, batch size may be a larger number. The predicted token 909 may be stored in a buffer. In some embodiments, the predicted token 909 may be used to update the input sequence 903. For instance, the predicted token 909 may be added to the right of the input sequence 903. The updated input sequence may be used as the input sequence in the second inference phase. In the second inference phase, the decoder 920 may receive the updated input sequence and the output tensor 902 for predicting another token. The output tensor 902 may remain the same during inference of the decoder 920. Certain aspects of subsequent inference processes are described below in conjunction with FIG. 9B.

In some embodiments, the self-attention key tensor 905 and the self-attention value tensor 906 may be provided to a self-attention layer in the decoder 920, an example of such a self-attention layer is the MHA layer 151. The self-attention key tensor 905 may be stored in a self-attention key cache. The self-attention key cache may have the same shape as the self-attention key tensor 905. The self-attention value tensor 906 may be stored in a self-attention value cache. The self-attention value cache may have the same shape as the self-attention value tensor 906.

In some embodiments, the decoder 920 computes the self-attention key tensor 905 and the self-attention value tensor 906 from the input sequence 903. The input sequence 903 may be dynamic during inference of the decoder 920. For instance, a new token may be added to the input sequence 903 after each inference phase, as described above. As the input sequence 903 changes, the self-attention key tensor 905 and the self-attention value tensor 906 would also change. For instance, the dimension of the self-attention key tensor 905 or the self-attention value tensor 906 along the X axis may increase as SLᵢₙₚᵤₜ increases. The self-attention key cache and the self-attention value cache may change during all the inference phases of the decoder 920 to accommodate the changes in the self-attention key tensor 905 and the self-attention value tensor 906.

In some embodiments, the cross-attention key tensor 907 and the cross-attention value tensor 906 may be provided to a cross-attention layer in the decoder 920, an example of such a cross-attention layer is the MHA layer 153. The cross-attention key tensor 907 may be stored in a cross-attention key cache. The cross-attention key cache may have the same shape as the cross-attention key tensor 907. The cross-attention value tensor 908 may be stored in a cross-attention value cache. The cross-attention value cache may have the same shape as the cross-attention value tensor 908. In some embodiments, the decoder 920 computes the cross-attention key tensor 907 and the cross-attention value tensor 906 from the output tensor 902 generated in the encoder 910. As the output tensor 902 does not change during inference of the decoder 920, the cross-attention key tensor 907 and the cross-attention value tensor 906 may remain the same during all the inference phases of the decoder 920. The cross-attention key cache and the cross-attention value cache may remain the same during all the inference phases of the decoder 920.

FIG. 9B illustrates subsequent inference processes of the transformer model 900, in accordance with various embodiments. In the second inference phase, the decoder 920 may reuse the self-attention key tensor 905, self-attention value tensor 906, cross-attention key tensor 907, and cross-attention value tensor 908. The decoder 920 also receives the predicted token 909. The decoder 920 may compute self-attention key vectors from the predicted token 909 and concatenate the self-attention key vectors with the self-attention key tensor 905 to generate a new self-attention key tensor 915. For instance, a self-attention key vector for each head may be added to the right of a self-attention key matrix in the self-attention key tensor 905, and the self-attention key vector and the self-attention key matrix may correspond to the same head. The elements highlighted with a dot pattern in the self-attention key tensor 915 are the self-attention key vectors generated from the predicted token 909.

Similarly, the decoder 920 may compute self-attention value vectors from the predicted token 909 and concatenate the self-attention value vectors with the self-attention value tensor 906 to generate a new self-attention value tensor 916. For instance, a self-attention value vector for each head may be added to the right of a self-attention value matrix in the self-attention value tensor 906, and the self-attention value vector and the self-attention value matrix may correspond to the same head. The elements highlighted with a dot pattern in the self-attention value tensor 916 are the self-attention value vectors generated from the predicted token 909.

The decoder 920 also generates an output tensor 914. The decoder 920 may generate the output tensor 914 using the new self-attention key tensor 915 and new self-attention value tensor 916. The output tensor 914 is used by the head 930 to generate another predicted token 919. The predicted token 919 is the output of the transformer model 900 in the second inference phase.

One or more other subsequent inference processes may be conducted. In each subsequent inference phase, the decoder 920 receives a token predicted in the previous inference phase, a self-attention key tensor generated in the previous inference phase, a self-attention value tensor generated in the previous inference phase, the cross-attention key tensor 907, and the cross-attention value tensor 908. The decoder 920 may, in the subsequent inference phase, generate a larger self-attention key tensor and a larger self-attention value tensor, in addition to an output tensor which can be used by the head 930 to predict a new token.

In embodiments where the total number of inference phases is N, the input sequence 903 is updated to an input sequence 913 after N−1 inference phases. In the last inference phase (i.e., the Nth inference phase), the decoder 920 may receive the predicted token generated in the (N−1)th inference phase, the self-attention key tensor generated in the (N−1)th inference phase, the self-attention value tensor generated in the (N−1)th inference phase, the cross-attention key tensor 907, and the cross-attention value tensor 908. The decoder 920 may generate a self-attention key tensor 925 and a self-attention value tensor 926 using the predicted token generated in the (N−1)th inference phase, the self-attention key tensor generated in the (N−1)th inference phase, and the self-attention value tensor generated in the (N−1)th inference phase. The dimensions of the self-attention key tensor 925 or self-attention value tensor 926 along the X axis is SLᵢₙₚᵤₜ+N. The decoder 920 also generates an output tensor 924, which is used by the head 930 to generate the last predicted token 929. The N tokens predicted by the transformer model in the N inference phases may constitute an output tensor 939, which may be the final output of the transformer model.

FIG. 10 is a block diagram of a NPU 1000, in accordance with various embodiments. The NPU 1000 can execute DNNs, including transformer models described above. For instance, the NPU 1000 can execute layers in a DNN by carrying out neural network operations in the layers. The layers may be arranged in a sequence, and the NPU 1000 may execute the layers in the sequence. The execution of the DNN may be for training the DNN or for using the DNN to perform AI tasks. The NPU 1000 may be an example of the NPU 450 in FIG. 4. The NPU 1000 may also be an example of the processing unit 640 in FIG. 6. As shown in FIG. 10, the NPU 1000 includes a memory 1010, a direct memory access (DMA) engine 1020, and compute blocks 1030 (individually referred to as “compute block 1030”). In other embodiments, alternative configurations, different or additional components may be included in the NPU 1000. For example, the NPU 1000 may include more than one memory 1010 or DMA engine 1020. As another example, the NPU 1000 may include a single compute block 1030. Further, functionality attributed to a component of the NPU 1000 may be accomplished by a different component included in the NPU 1000 or by a different system. A component of the NPU 1000 may be implemented in hardware, software, firmware, or some combination thereof.

The memory 1010 stores data associated with neural network operations performed by the NPU 1000. In some embodiments, the memory 1010 may store data to be used by the compute blocks 1030 for executing neural network operations. The memory 1010 may store inputs to DNNs and outputs of DNNs. The memory 1010 may also store activations (such as input activations and output activations of neural network operations) and weights (such as weights determined by training DNNs) in DNNs. In some embodiments, the memory 1010 may store activations and weights with floating-point precisions, such as FP4, SF4, NF4, FP16, BP16, FP32 and so on. The memory 1010 may also quantized activations or weights. The memory 1010 includes one or more DRAMs.

The DMA engine 1020 facilitates data transfer between the memory 1010 and the compute blocks 1030. For example, the DMA engine 1020 can read data from the memory 1010 and write data into a local memory of a compute block 1030. As another example, the DMA engine 1020 can read data from a local memory of a compute block 1030 and write data into the memory 1010. For instance, the DMA engine 1020 may read input activations and weights of convolution from the memory 1010 and load the input activations and weights to one or more compute blocks 1030. The DMA engine 1020 may also write output activations of convolutions computed by one or more compute blocks 1030 to the memory 1010. The DMA engine 1020 provides a DMA feature that allows the compute block 1030 to initiate data transfer between the memory 1010 and the local memories of the compute blocks 1030 and to perform other operations while the data transfer is being conducted. In some embodiments, the DMA engine 1020 may read tensors from the memory 1010, modify the tensors in a way that is optimized for the compute block 1030 before it writes the tensors into the local memories of the compute blocks 1030.

The compute blocks 1030 perform neural network operations in DNNs. For instance, a compute block 1030 may execute a DNN layer by running one or more deep learning operations in the DNN layer. A compute block 1030 may execute a layer, or a portion of a layer, at a time. In some embodiments, the operations of the DNN layers may be run by multiple compute blocks 1030 in parallel. For instance, multiple compute blocks 1030 may each perform a portion of a workload for a neural network operation. Data may be shared between the compute blocks 1030. A compute block 1030 may also be referred to as a compute tile. The compute blocks 1030 may be capable of running various types of neural network operations, such as convolution, matrix multiplication, SoftMax operation, pooling, elementwise operation, linear operation, nonlinear operation, and so on. Neural network operations performed by the compute blocks 1030 include tensor operations, i.e., operations whose inputs are tensors or operations whose outputs are tensors. In an example, the compute block 1030 receives an input tensor and one or more convolutional kernels and performs a convolution with the input tensor and convolutional kernels. The result of the convolution may be an output tensor, which can be further computed, e.g., by the compute block 1030 or another compute block 1030.

In the embodiments of FIG. 10, each compute block 1030 includes a local memory 1040, a digital signal processor (DSP) 1050, and a data processing unit (DPU) 1055. The DPU 1055 includes an input delivery unit (IDU) 1060, a processing engine 1070, a post-processing engine 1080, and an output delivery unit (ODU) 1090. Some or all the components of the compute block 1030 can be implemented on the same chip. In other embodiments, alternative configurations, different or additional components may be included in the compute block 1030. Further, functionality attributed to a component of the compute block 1030 may be accomplished by a different component included in the compute block 1030, a different compute block 1030, another component of the NPU 1000, or a different system. A component of the compute block 1030 may be implemented in hardware, software, firmware, or some combination thereof.

The local memory 1040 is local to the corresponding compute block 1030. The local memory 1040 is accessible to both the DSP 1050 and DPU 1055. In the embodiments of FIG. 10, the local memory 1040 is inside the compute block 1030. In other embodiments, the local memory 1040 may be outside the compute block 1030. Data in the local memory 1040 may be transferred to or from the memory 1010, e.g., through the DMA engine 1020. In some embodiments, data in the local memory 1040 may be transferred to or from the local memory of another compute block 1030. The local memory 1040 may store data received, used, or generated by the IDU 1060, the processing engine 1070, the post-processing engine 1080, or the ODU 1090. Examples of the data may include input activations, weights, output activations, configuration parameters, and so on.

In some embodiments, the local memory 1040 includes one or more static random-access memories (SRAMs). The local memory 1040 may be byte-addressable, and each memory address identifies a single byte (eight bits) of storage. In some embodiments, the local memory 1040 may include memory banks. The number of data banks in the local memory 1040 may be 16, 64, 128, 1056, 512, 1024, 2048, or other numbers. A memory bank may include a plurality of storage units. In an example, a data bank may include 8, 16, 64, or a different number of storage units. A memory bank or a storage unit in a memory bank may have a memory address. In an example, a storage unit may store a single byte, and data larger than a single byte may be stored in storage units with consecutive memory addresses, i.e., adjacent storage units. For instance, a storage unit can store an integer number in the INT8 format, versus two storage units may be needed to store a number in the FP16 or BF16 format, which has 16 bits. In some embodiments, 16 bits can be transferred from the local memory 1040 in a single read cycle. In other embodiments, 16 bits can be transferred from the local memory 1040 in multiple read cycles, such as two cycles.

The DSP 1050 performs computations in DNN layers, including computations in group quantization-based neural network operations. In some embodiments, the DSP 1050 can perform generic computations such as addition, subtraction, multiplication, division, logical, bitwise operations, and other nonlinear computations (in terms of table look-up or polynomial approximation). The DSP 1050 may be a very long instruction word (VLIW) processor. In some embodiments, the DSP 1050 may have an architecture optimized for the operational needs of digital signal processing. In some embodiments, the DSP 1050 may perform some computations in a neural network operation, while other computations in the neural network operation may be performed by the DPU 1055. The DSP 1050 may support non-traditional operations or non-MatMul or non-convolution-based operations within DNNs.

In some embodiments, the DSP 1050 may operate in accordance with a clock signal. For instance, the timing when the DSP 1050 can execute instructions may be synchronized with the clock signal. In some embodiments, the DSP 1050 may be pipelined along with the DMA engine 1020 or the DPU 1055, thereby enabling parallel computations to improve overall performance. The DSP 1050 may be implemented on a microprocessor chip, which may be separate from a chip implementing the DPU 1055. In some embodiments, the DSP 1050 may be a Streaming Hybrid Architecture Vector Engine (SHAVE) processor. Even though FIG. 10 shows a single DSP, the compute block 1030 may include multiple DSPs. The DSPs may be arranged in an array.

The IDU 1060 loads data from the local memory 1040 to the processing engine 1070 or to the post-processing engine 1080. The IDU 1060 may read tensors from the local memory 1040. The tensors may include activation tensors, weights tensor, and so on. The IDU 1060 may perform group-wise loading of activations or weights. In some embodiments, the IDU 1060 may read data from the local memory 1040 and write the data into storage units in the processing engine 1070. For instance, the IDU 1060 may load activations into activation register files in the processing engine 1070 and load weights into weight register files in the processing engine 1070. The IDU 1060 may have an activation reader for loading activations and a weight reader for loading weights. In some embodiments, the IDU 1060 may read configuration parameters from the local memory 1040 and load the configuration parameters into configuration registers or other configurable components (e.g., LUTs) of the processing engine 1070 or post-processing engine 1080.

The processing engine 1070 performs operations in DNNs. The processing engine 1070 may include one or more processing cells. In some embodiments, the processing cells may be arranged in one or more rows and one or more columns in the processing engine 1070. Each processing cell may include processing elements (PEs) that may be arranged in an array that includes rows and columns. All the PEs in the processing engine 1070 may constitute a bigger array that includes more rows and columns. An example PE may be or may include one or more multiply-accumulate (MAC) units that can perform MAC operations. In some embodiments (e.g., embodiments where the compute block 1030 executes a convolutional layer), a computation in an MAC unit may be an MAC operation on an activation operand and a weight operand. The activation operand may be an activation tensor that may include one or more activations in the input tensor of the convolution. Different activations may be in different input channels. The weight operand may be a weight tensor that may include one or more weights in the filter of the convolution. The values of the weights are determined through training the DNN or compressing the neural network operation after training. The weights in the weight operand may be in different input channels. In some embodiments, the activation operand or weight operand is a vector along the input channel dimension.

In some embodiments, an MAC unit includes one or more multipliers for performing multiplications. An MAC unit may also include one or more accumulators (“adders”) for performing accumulations. An MAC unit may also include one or more shifters to facilitate mixed-precision computations. A column of MAC units is referred to as an MAC column. An MAC column may be associated with one or more MAC lanes. A MAC lane is a path for loading data e.g., by the IDU 1060, into an MAC column. A MAC lane may be also referred to as a data transmission lane or data loading lane. An MAC column may have multiple MAC lanes. The loading bandwidth of the MAC column is an aggregation of the loading bandwidths of all the MAC lanes associated with the MAC column. With a certain number of MAC lanes, data can be fed into the same number of independent MAC units simultaneously. In some embodiments where an MAC column has four MAC lanes for feeding activations or weights into the MAC column and each MAC lane may have a bandwidth of 16 bytes, the four MAC lanes can have a total loading bandwidth of 64 bytes.

In some embodiments, a processing cell may have a sparsity logic unit for accelerating computations in DNNs based on data sparsity. For instance, the sparsity logic unit may obtain or generate a sparsity bitmap and use the sparsity bitmap to identify nonzero values in the activation register files or weight registers files and send nonzero values to the PEs for performing computation, while zero values in the activation register files or weight registers files are skipped.

The post-processing engine 1080 processes outputs of the processing engine 1070. The post-processing engine 1080 may include one or more post-processing elements (PPEs). In some embodiments, the PPEs in the post-processing engine 1080 may be arranged in an array that has rows and columns. In some embodiments, the post-processing engine 1080 computes activation functions. The post-processing engine 1080 may receive outputs of the processing engine 1070 as inputs to the activation functions. In addition or alternative to activation functions, the post-processing engine 1080 may perform other types of post processing on outputs of the processing engine 1070. For instance, the post-processing engine 1080 may apply a bias on an output of the processing engine 1070. In some embodiments, the post-processing engine 1080 may be bypassed for certain neural network operations.

The ODU 1090 drains data from the processing engine 1070 or from the post-processing engine 1080, e.g., from register files in the processing engine 1070 or from the post-processing engine 1080. The drain module may write the data to the local memory 1040. The drained data may be tensors, such as output tensors of neural network operations. In some embodiments, the ODU 1090 may drain data on a cell level. For each processing cell, the ODU 1090 may drain outputs of PEs in the processing cell based on a row index or column index of each PE. For instance, the ODU 1090 may use a sequence of cycles to drain data from a processing cell. The ODU 1090 may drain the output of some of the PEs in each cycle. The sequence of the cycles may be configured based on a configuration parameter indicating the operation mode of the IDU 1060.

In some embodiments, the ODU 1090 includes sparsity encoding logic that can convert outputs of the processing engine 1070 from a dense format to a sparse format. For instance, the ODU 1090 may be implemented with one or more sparsity encoders. A sparsity encoder converts dense data to compressed data based on sparsity in the dense data. For instance, the sparsity encoder may remove zeros from data computed by the processing engine 1070. The sparsity encoder may also generate sparsity maps that represent sparsity in the dense data.

In some embodiments, the data drained from the processing engine 1070 may be output data elements of a DNN layer. The sparsity encoder may generate a compressed version of the output tensor. The sparsity encoder may identify every zero activation in the output tensor and remove these activations from the output tensor to generate a compressed activation tensor (aka “sparse activation tensor”). The sparsity encoder may also generate one or more sparsity maps for the output tensor. A sparsity map may indicate sparsity in at least part of the output tensor. The sparsity map may include sparsity elements (e.g., bits), each of which corresponds to a different activation in the vector and indicates whether the corresponding activation is zeroed or not.

The ODU 1090 may write the compressed activation tensor and the one or more sparsity maps into the local memory 1040. The sparse activation tensor and the one or more sparsity maps may be further loaded to the memory 1010, e.g., through the DMA engine 1020. Additionally or alternatively, the sparse activation tensor and the one or more sparsity maps may be loaded by the IDU 1060 to the processing engine 1070 for further computation, e.g., for performing a deep learning operation in the next layer.

FIG. 11 illustrates an IC device 1100 that implements a model on silicon, in accordance with various embodiments. In some embodiments, the IC device 1100 may embed inference of a transformer-based model, such as an LLM. The IC device 1100 can provide and implement at least a part of the model in a single chip, such as a silicon chip. The IC device 1100 may be an example of the IC device 420 in FIG. 4 or the IC devices 610B-610E in FIG. 6.

As shown in FIG. 11, the IC device 1100 receives tokens in and outputs tokens out. The entire architecture, weights, and flow of the model can be embedded into the IC device 1100. The IC device 1100 includes an embedder unit 1110, root mean square (RMS) normalizer unit 1120, flow control unit 1130, sampler unit 1140, and etched mind unit 1150. The etched mind unit 1150 includes a rotary embedder unit 1155, SILU unit 1160, SoftMax unit 1165, embedding dot unit 1170, memories 1175, attention dot unit 1180, and SRAMs 1185. A unit in the IC device 1100 may be a circuit or may include multiple circuits. In other embodiments, the IC device 1100 may include fewer, more, or different components. For instance, the IC device 1100 may include more than one embedder unit 1110, RMS normalizer unit 1120, flow control unit 1130, sampler unit 1140, etched mind unit 1150, rotary embedder unit 1155, SILU unit 1160, SoftMax unit 1165, embedding dot unit 1170, or attention dot unit 1180. Further, functionality attributed to a component of IC device 1100 may be accomplished by a different component included in the IC device 1100 or a different device.

The embedder unit 1110 may implement an embedder (e.g., an embedding layer) in the module. The embedder unit 1110 may execute the embedding layer to convert input tokens to embedding vectors. In some embodiments, the embedder unit 1110 may include look-up tables that map vocabulary of the model to embedding elements. The look-up tables may output embedding elements corresponding to the input tokens. The embedding elements may constitute the embedding vector of the input tokens.

In an example, the embedder unit 1110 includes 256 look-up tables. The look-up tables may have the same storage size, e.g., 1000 KB. Each of the look-up tables may have 1112,000 lines. In some embodiments, the look-up tables may be implemented on one or more read-only memories (ROMs). In an example, the 256 look-up tables are implemented on 256 ROMs, respectively. The embedder unit 1110 may receive an input token. In the example shown in FIG. 11, the embedder unit 1110 receives an input token represented by 15 bits. The input token may have an integer format. The embedder unit 1110 may also receive control signals. For instance, the embedder unit 1110 receives an embedder cycle signal, which may have 10 bits. The embedder unit 1110 also receives an embedder run signal, which may have 1 bit. The embedder unit 1110 may also receive an embedder on/off signal, which may have 1 bit.

The output of the embedder unit 1110 may be an embedding vector of the input token. For instance, the embedder unit 1110 may produce an embedding vector with floating-point (e.g., FP16) data elements. The dimension of the embedding vector may indicate the total number of data elements in the embedding vector. In an example, the dimension of the embedding vector may be 10,096. In some embodiments, the embedder unit 1110 may receive 32,000 tokens. The total embedder size may be 250 MB, which equals 10,096×32,000×2B. Each of the tokens in the vocabulary may be broken into 16 chunks of 256 numbers. In some embodiments (e.g., embodiments where the look-up tables are stored in ROMs), the first out of 16 numbers may be read from the table. Reading from the ROM may be sequential for 16 cycles, so the next line is to be pre-charged but it may be unnecessary to pre-charge other lines. Within each cycle, the 256 look-up tables may output 256 embedding vector elements, respectively. The embedder unit 1110 may return 256 elements every clock cycle for 16 clocks cycles. After finishing the 16 cycles, the embedder unit 1110 may be idle for about 10,000 cycles. Power gating may be used.

The RMS normalizer unit 1120 implements one or more RMS normalizer functions in the model. An RMS normalizer function may be denoted as:

$$\frac{{x}_{i} \cdot {W}_{{RMS}_{i}}}{\sqrt{\frac{{\sum }_{j = 0}^{4 , 096} {x}_{j}^{2}}{4 , 096} + {10}^{- 5}}}$$

In some embodiments, the RMS normalizer unit 1120 may receive an input vector (e.g., 4096 FP16 elements) and return an RMS-normalized vector (e.g., 4096 elements in FP8 format). The RMS normalizer unit 1120 may receive 256 elements every clock for 16 clocks cycles. The RMS normalizer unit 1120 may include tree adder 1502 to add a number of values (e.g., 256 values) together simultaneously. The RMS normalizer unit 1120 may include ROM 1504 storing a look-up table comprising one or more precomputed values of the function:

$$f ( i ) = {\sqrt{\frac{x}{4 , 096} + 1 {0}^{- 5}}}^{- 1} .$$

The flow control unit 1130 plays a role in orchestrating various circuits to execute operations according to a predetermined timing sequence. The flow control unit 1130 may also be referred to as a sequencer unit, which can orchestrate one or more other components of the IC device 1100 according to a predetermined timing sequence of the model. The model may operate in a feedforward manner. The sequence of operations of the model corresponding to different layers of the neural network can be determined and mapped into a timing sequence of neural network operations. The timing sequence of neural network operations may include stages of operations, one following another. In a particular time slot or stage in the timing sequence, data can be moved in, processed, and moved out to be processed in the next/following time slot, in a feedforward, progressive manner. The flow control unit 1130 may implement digital logic to generate clock edges/signals (e.g., control signals, timing signals, enable signals, disable signals, trigger signals, etc.) to orchestrate operations to be performed according to the timing sequence. The flow control unit 1130 may control data flow into or out of one or more other components of the IC device 1100. The flow control unit 1130 may also enable or disable one or more other components of the IC device 1100 according to a predetermined timing sequence.

The sampler unit 1140 is a hardware implementation of one or more samplers in the model. The sampler unit 1140 may receive an input vector and compare elements of the input vector to find the largest value. The sampler unit 1140 may determine the index of the largest number and return a token. In some embodiments, the sampler unit 1140 may receive a logits vector. In an example, the vector may include 32,000 elements. In some embodiments, the sampler unit 1140 may receive 256 input elements for a cycle and may take 125 cycles to process the 32,000. The input elements may be in FP16 format. The total number of bits for the 256 input elements may be 4,096 bits. In some embodiments, the 256 input elements may be received from 256 MatMul units, such as 256 attention dot units, respectively. In some embodiments, the sampler unit 1140 may implement a deterministic sampler having zero temperature. The sampler unit 1140 may also receive control signals, such as an on/off signal indicating whether the sampler unit 1140 is to be on or off, a restart signal indicating whether to restart the sampler unit 1140, and a run signal. A control signal may have 1 bit. The sampler unit 1140 may determine an index, such as a 32-bit index, corresponding to the largest number in the input vector. The index may correspond to an output token. In some embodiments, the output token may be a 15-bit integer.

In some embodiments, the sampler unit 1140 includes 256 sampling comparators. In other embodiments, the sampler unit 1140 may include a different number of sampling comparators. With the 256 sampling comparators, the sampler unit 1140 can compare 256 input elements every clock cycle and keeps the index and value of the largest number. Each sampling comparator may compare two logits or values in a single clock cycle and return the larger number of its index (token). Each value may have 16 bits and may be in the FP16 format. The index (token) may be a 15-bit integer. The output may include the larger value as well as the index of the larger value. In a situation where more than one number has the largest value, the sampler unit 1140 may return the token with the lowest index out of the equal tokens. When finishing the 125 clock cycles, the sampler unit 1140 returns the token of the largest value in the input vector. For instance, the sampler unit 1140 may output the index of the largest value in the input vector.

In some embodiments, the sampler unit 1140 may have sampling comparators arranged in a tree or hierarchical structure to efficiently compare a large number of values (e.g., hundreds or thousands of values or more) simultaneously. For instance, each comparator in the first tier may compare two values in the input vector and select the larger value, each comparator in the second tier may compare two values from two comparators, respectively, in the first tier, each comparator in the third tier may compare two values from two comparators, respectively, in the second tier, and so on. The last tier may include a comparator that outputs the largest value of the input vector. In some embodiments, the sampler unit 1140 may have a latency of 9 clock cycles. Every layer of comparators may be pipeline. In some embodiments, the sampler unit 1140 may have power gating.

The etched mind unit 1150 is a hardware implementation of other layers or neural network operations in the model. The rotary embedder unit 1155 may be the hardware implementation of one or more rotary position encoders in the model, which may produce rotary positional encoded embeddings. The rotary embedder unit 1155 may provide the functionality of a sine cosine unit without the need to calculate/compute sine and cosine in real-time. The rotary embedder unit 1155 may have a sine cosine unit that has a look-up table implementation. In some embodiments, the rotary embedder unit 1155 may include a look-up table comprising one or more precomputed values of a cosine function

$$( e . g . , f ( t ) = cos ( {10}^{- \frac{{h}_{n}}{16}} \cdot t ) ) .$$

The rotary embedder unit 1155 may include another look-up table comprising one or more precomputed values of sine function

$$( e . g . , f ( t ) = sin ( {10}^{- \frac{{h}_{n}}{16}} \cdot t ) ) .$$

The SILU unit 1160 is a hardware implementation of one or more SILU activators in the model. The SILU unit 1160 may include a look-up table having one or more precomputed values of a SILU function:

$$f ( t ) = \frac{x}{1 + {e}^{- x}}$$

In some cases, the SILU unit 1160 includes a multiplexer (MUX) controller and a MUX. The MUX controller may check whether the input value meets a particular condition and selects a particular value to use as the output of SILU unit 1160. The MUX controller may output a 2-bit value as selection signal for the MUX, to select one of three possible values to use as the output. For example, when the sign bit is 0 and the most-significant bits (MSBs) of the input are “11”, the input is selected by the MUX and passed on to use as the output. When the sign bit is 1 and the MSBs of the input are “11”, the value of “0” is selected by the MUX to use as the output. Otherwise, the value from the look-up table is used as the output.

The SoftMax unit 1165 is a hardware implementation of one or more SoftMax activators in the model. The SoftMax unit 1165 may execute a SoftMax function using one or more look-up tables that are pre-configured with precomputed data. The SoftMax function may be:

$$\frac{{e}^{\frac{{x}_{i} - {x}_{max}}{\sqrt{128}}}}{{\sum }_{j - 0}^{t} {e}^{\frac{{x}_{j} - {x}_{max}}{\sqrt{128}}}}$$

In some embodiments, the SoftMax unit 1165 includes look-up table implementation of the SoftMax function instead of a compute-oriented solution. In some embodiments, the SoftMax unit 1165 receives an input vector of t FP16 elements (1<t<512) and returns the SoftMax normalized vector of the same size. The SoftMax unit 1165 receives 16 numbers per cycle for up to 32 cycles and returns 16 numbers per cycle for up to 32 cycles.

In an example, the SoftMax unit 1165 receives an input vector including 16 elements, each of which is a FP16 value, in a clock cycle. The total number of bits of the input vector is 256. The SoftMax unit 1165 may also receive a compare control signal, normalize control signal, exponent control signal, multiply control signal, on/off control signal, other types of control signals, or some combination thereof. A control signal may have 1 bit. The output of the SoftMax unit 1165 may be 16 elements with UFP16 format. The total number bits may be 240. The SoftMax unit 1165 may execute the SoftMax function using 16 clock cycles. Numbers may be stored in a first-in-first-out (FIFO) buffer while they are compared to find the largest number in the vector. The FIFO buffer may output numbers. The largest number may be subtracted. The subtraction result is provided to a look-up table. The output of the look-up table enters a second FIFO. Numbers may be pulled out of the second FIFO and multiplied by the normalization value. It may take a total of 24 cycles to compute the output. The 24 cycles may include 8 latency cycles and 16 piping cycles

In some embodiments, the SoftMax unit 1165 may be included in the attention dot unit 1180 to perform SoftMax on an input vector (e.g., FP16 vector) and to output a SoftMax-ed vector (e.g., FP16 vector). The SoftMax unit 1165 may include a look-up table comprising one or more precomputed values of an exponent function:

$$f ( x ) = {e}^{\frac{x}{\sqrt{128}}} .$$

The SoftMax unit 1165 may include another look-up table comprising one or more precomputed values of a reciprocal function:

$$f ( x ) = \frac{1}{x} .$$

The SoftMax unit 1165 may include a tree adder that can add a number of values (e.g., 18 values) together simultaneously.

The embedding dot unit 1170 is a hardware implementation of MatMul operators and add operators in the model, such as the MatMul operators and add operators in the encoders of the model. In some embodiments, the embedding dot unit 1170 may include a tree adder and multipliers. The tree adder may also be referred to as an adder tree and may include adders arranged in a tree structure. In one implementation, the embedding dot unit 1170 may carry out a (4096-elements) dot product operation between FP8 embedding vector and FP6 weights vector. The dot product operation can be performed using one or more tree adders and one or more multipliers in the embedding dot unit 1170. A multiplier may multiple two values, such as two floating-point values. The two values may have different data formats or precisions. For example, the embedding dot unit 1170 may include one or more FP4/FP6 multipliers, one or more FP4/FP8 multipliers, or one or more FP6/FP8 multipliers. One or more multipliers in the embedding dot unit 1170 may be specifically designed to perform multiplication of values or data having predetermined representations (e.g., FP4, FP6, FP8, FP12, INT8, etc.).

In an example, the embedding dot unit 1170 includes a multiplier unit, an adder unit, and a sampler. In other embodiments, the embedding dot unit 1170 may include fewer, more, or different components. The multiplier unit may perform elements dot product operation between an embedding vector (e.g., FP8 embedding vector) and a weights vector (e.g., FP6 weights vector read from sequential read-only memory) every cycle. The multiplier unit includes a plurality of weights multipliers. The embedding dot unit 1170 may include 4,096 weights multipliers: weights multiplier #1 through weights multiplier #4,096. The weights multipliers may perform multiplication in parallel. The outputs (e.g., 4096 outputs) may be added together by the adder unit. The adder unit includes 4,095 adders. These adders are arranged in a tree or hierarchical structures. In some embodiments, the adder unit may use a special fixed-point adder with a relatively large number of bits (e.g., 20 bits, 21 bits, . . . 32 bits). The 4,095 adders may be arranged in 17 tiers. A tier is a level in the tree structure. The first tier includes 2,048 adders, for instance. Each adder in the first tier sums two products from two weights multipliers, respectively. Each adder in the second tier sums the outputs of two adders in the first tier. Each adder in the third tier sums the outputs of two adders in the second tier. This continues till adder #4095 is reached. The adder in the 17^{th} tier outputs the final sum, which may be a 33-bit number, which is then provided to the sampler. The sampler may be a FP16 sampler. The sampler may resample the final sum into a floating-point representation. The embedding dot unit 1170 may generate an FP16 output. Using a large number of bits in the adder unit can prevent overflow during many stages/layers of adding.

As shown in FIG. 11, the embedding dot unit 1170 is coupled with the memories 1175. The memories 1175 may store and provide data (e.g., weight vector) to the embedding dot unit 1170. In some embodiments, the memories 1175 may be DRAMs. In other embodiments, the memories 1175 may be ROMs, such as sequential read-only memories. Sequence read-only memory is a type of memory storage, utilizing ROMs, that allows data to be read sequentially but not written or modified after the values have been etched onto the ROM. The rest of the ROM can be shut down to reduce power and area. In an example, a sequential read-only memory has six word lines. The sequential read-only memory can power up an active current word line and an active next word line at a time, while other word lines can be powered down. The active current word line refers to the word line having data being used or processed by a circuit to perform an operation during a time slot in the predetermined timing sequence. The active next word line refers to the word line having data being used or processed by the circuit to perform an operation during a further/next time slot in the predetermined timing sequence. The sequential read-only memory can power down the rest of the word lines, or the rest of the word lines in the sequential read-only memory can remain powered down. At the next clock or time slot, the active current word line is powered down, the active next word line is already powered up, and a further active next word line is powered up. At every clock or time slot, two word lines may be powered up in the sequential read-only memory. The two active word lines that are powered up may get moved by one word line down the sequential read-only memory at every clock or time slot.

In some embodiments, the IC device 1100 may have 1,048,576 ROMs (e.g., sequential read-only memories) for storing weights. A ROM may hold weights in FP6 format. A ROM output may be a 6-bit value. A weights ROM may hold a specific weight matrix column, since a weights ROM can output a single number out of the 4096-element vector being multiplied in the EDU. A weights ROM may hold one of 256 weight matrix rows, e.g., when there are 256 embedding dot units working in parallel and producing 256 numbers per clock cycle. A ROM may hold matrix rows 1, 257, . . . , and another ROM can hold matrix rows 2, 258, and so forth. In some cases, a weights ROM may hold elements from (all) weights matrices in (all) layers, since a weights ROM sequentially outputs the number the matrix multiplier is using for (all) transformers and matrices, as the weights multipliers are shared across all layers and weights matrices. The weights ROM may hold (only) the linear layers' weights. There may be one or more dedicated ROMs for the embedder unit and RMS normalizer unit.

In some embodiments, the memories 1175 may be placed in proximity to the components performing logic operations in the embedding dot unit 1170, such as multipliers in the embedding dot unit 1170. Each multiplier may be coupled with and proximate to a corresponding memory 1175 and may receive data (e.g., one or more weights) from the memory 1175. As data is located where it is needed, the embedding dot unit 1170 can be very efficient. One or more tree adders may add multiplication results produced by one or more multipliers together.

The attention dot unit 1180 is a hardware implementation of MatMul operators and add operators in the model, such as the MatMul operators and add operators in the decoders of the model. In one implementation, the attention dot unit 1180 may carry out a (128-elements) dot product operation between FP16 input vector and FP16 K or V vector cached in one or more SRAMs 1185, e.g., every cycle. The dot product operation can be performed using one or more tree adders and one or more multipliers in the attention dot unit 1180. A multiplier may multiple two values, such as two floating-point values. In an example, the attention dot unit 1180 one or more FP16/FP16 multipliers. A multiplier may be specifically designed to perform multiplication of data having predetermined representations (e.g., FP4, FP6, FP8, FP12, FP16, INT8, etc.). One or more multipliers in the attention dot unit 1180 may receive data from one or more SRAMs 1185. One or more tree adders may add multiplication results produced by one or more multipliers together.

The SRAMs 1185 can store and provide data to one or more circuits performing logic operations in the attention dot unit 1180. One or more SRAMs 1185 may include one or more sequential read/write memories, which may be placed in proximity to the circuits performing logic operations in the attention dot unit 1180. For instance, a SRAM 1185 may store a KV cache. The KV cache may be dynamic during inference of the model. New keys or values may be written into the SRAM 1185 as they are generated.

In some embodiments, a SRAM 1185 may be a sequential read/SRAM, which is an example of a sequential read/write memory. The SRAM 1185 may be used in a special configuration where it is not dynamically readable but is built up sequentially to reduce power and area. A SRAM 1185 that can be read sequentially or written sequentially may have drastically simplified logic and circuitry for reads or writes. A sequential read/write memory can be used with or in an attention dot unit to supply weights to a multiplier in the attention dot unit 1180. The sequential read/write memory may be referred to as Key-Value SRAM (KV SRAM), which can store data in key-value pairs. KV SRAM can enable storing the attention history (e.g., cached keys and values) of a transformer block. In some embodiments, the attention dot unit 1180 may receive an input number and multiplies it by a number from the SRAM 1185 in every clock cycle. 64 SRAMs 1185 may be used to store the 32 layers and K vs. V separately, so the SRAM can read lines sequentially.

Certain aspects of hardware implementing models on silicon are further described in U.S. patent application Ser. No. 19/281,006, filed on Jul. 25, 2025, U.S. patent application Ser. No. 19/275,640, filed on Jul. 21, 2025, and U.S. patent application Ser. No. 19/244,318, filed on Jun. 20, 2025, each of which is hereby incorporated by reference in its entirety.

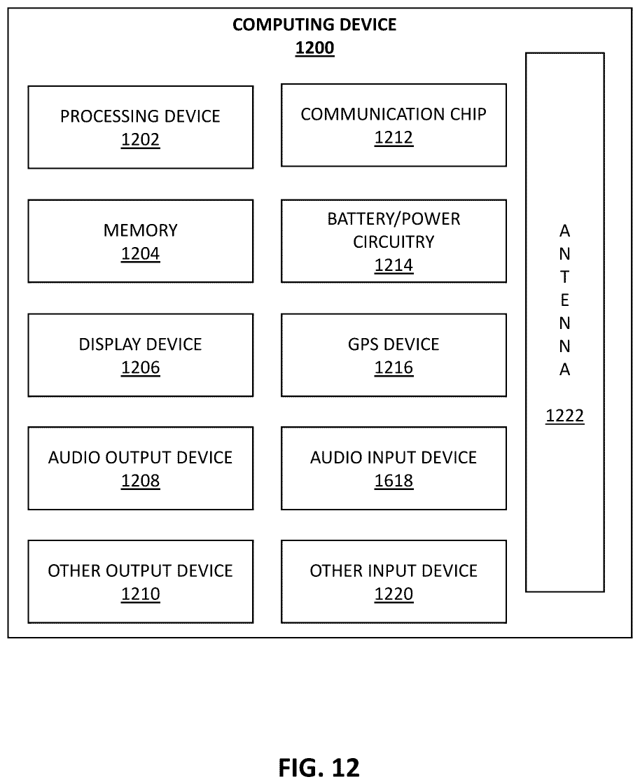

FIG. 12 is a block diagram of an example computing device 1200, in accordance with various embodiments. In some embodiments, the computing device 1200 can be used as at least part of the speculative decoding system 400 in FIG. 4. A number of components are illustrated in FIG. 12 as included in the computing device 1200, but any one or more of these components may be omitted or duplicated, as suitable for the application. In some embodiments, some or all of the components included in the computing device 1200 may be attached to one or more motherboards. In some embodiments, some or all of these components are fabricated onto a single system on a chip (SoC) die. Additionally, in various embodiments, the computing device 1200 may not include one or more of the components illustrated in FIG. 12, but the computing device 1200 may include interface circuitry for coupling to the one or more components. For example, the computing device 1200 may not include a display device 1206, but may include display device interface circuitry (e.g., a connector and driver circuitry) to which a display device 1206 may be coupled. In another set of examples, the computing device 1200 may not include an audio input device 1218 or an audio output device 1208 but may include audio input or output device interface circuitry (e.g., connectors and supporting circuitry) to which an audio input device 1218 or audio output device 1208 may be coupled.

The computing device 1200 may include a processing device 1202 (e.g., one or more processing devices). The processing device 1202 processes electronic data from registers and/or memory to transform that electronic data into other electronic data that may be stored in registers and/or memory. The computing device 1200 may include a memory 1204, which may itself include one or more memory devices such as volatile memory (e.g., DRAM), nonvolatile memory (e.g., ROM, high bandwidth memory (HBM), flash memory, solid state memory, and/or a hard drive. In some embodiments, the memory 1204 may include memory that shares a die with the processing device 1202. In some embodiments, the memory 1204 includes one or more non-transitory computer-readable media storing instructions executable to perform operations for speculative decoding (e.g., the method 700 described in conjunction with FIG. 7) or some operations performed by one or more components of the speculative decoding system 400 in FIG. 4. The instructions stored in the one or more non-transitory computer-readable media may be executed by the processing device 1202.

In some embodiments, the computing device 1200 may include a communication chip 1212 (e.g., one or more communication chips). For example, the communication chip 1212 may be configured for managing wireless communications for the transfer of data to and from the computing device 1200. The term “wireless” and its derivatives may be used to describe circuits, devices, systems, methods, techniques, communications channels, etc., that may communicate data through the use of modulated electromagnetic radiation through a nonsolid medium. The term does not imply that the associated devices do not contain any wires, although in some embodiments they might not.

The communication chip 1212 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1212 may operate in accordance with Code-division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1212 may operate in accordance with other wireless protocols in other embodiments. The computing device 1200 may include an antenna 1222 to facilitate wireless communications and/or to receive other wireless communications (such as AM or FM radio transmissions).

In some embodiments, the communication chip 1212 may manage wired communications, such as electrical, optical, or any other suitable communication protocols (e.g., the Ethernet). As noted above, the communication chip 1212 may include multiple communication chips. For instance, a first communication chip 1212 may be dedicated to shorter-range wireless communications such as Wi-Fi or Bluetooth, and a second communication chip 1212 may be dedicated to longer-range wireless communications such as global positioning system (GPS), EDGE, GPRS, CDMA, WiMAX, LTE, EV-DO, or others. In some embodiments, a first communication chip 1212 may be dedicated to wireless communications, and a second communication chip 1212 may be dedicated to wired communications.

The computing device 1200 may include battery/power circuitry 1214. The battery/power circuitry 1214 may include one or more energy storage devices (e.g., batteries or capacitors) and/or circuitry for coupling components of the computing device 1200 to an energy source separate from the computing device 1200 (e.g., AC line power).

The computing device 1200 may include a display device 1206 (or corresponding interface circuitry, as discussed above). The display device 1206 may include any visual indicators, such as a heads-up display, a computer monitor, a projector, a touchscreen display, a liquid crystal display (LCD), a light-emitting diode display, or a flat panel display, for example.

The computing device 1200 may include an audio output device 1208 (or corresponding interface circuitry, as discussed above). The audio output device 1208 may include any device that generates an audible indicator, such as speakers, headsets, or earbuds, for example.

The computing device 1200 may include an audio input device 1218 (or corresponding interface circuitry, as discussed above). The audio input device 1218 may include any device that generates a signal representative of a sound, such as microphones, microphone arrays, or digital instruments (e.g., instruments having a musical instrument digital interface (MIDI) output).

The computing device 1200 may include a GPS device 1216 (or corresponding interface circuitry, as discussed above). The GPS device 1216 may be in communication with a satellite-based system and may receive a location of the computing device 1200, as known in the art.

The computing device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The computing device 1200 may include another input device 1220 (or corresponding interface circuitry, as discussed above). Examples of the other input device 1220 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1200 may have any desired form factor, such as a handheld or mobile computer system (e.g., a cell phone, a smart phone, a mobile internet device, a music player, a tablet computer, a laptop computer, a netbook computer, an ultrabook computer, a personal digital assistant (PDA), an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1200 may be any other electronic device that processes data.

The following paragraphs provide various examples of the embodiments disclosed herein.
Example 1 provides an apparatus, including an IC device specific to a first DNN model, the IC device including hardware implementations of operators in the first DNN model, in which the IC device is to generate one or more speculative tokens from an input prompt by running the operators in the first DNN model; and a processing unit to: evaluate validity of the one or more speculative tokens by executing a second DNN model, and generate an output of the second DNN model based on the validity of the one or more speculative tokens.
Example 2 provides the apparatus of example 1, in which the one or more speculative tokens includes a plurality of speculative tokens, in which the processing unit is to evaluate validity of the plurality of speculative tokens in parallel.
Example 3 provides the apparatus of example 2, in which the IC device is to generate the plurality of speculative tokens sequentially.
Example 4 provides the apparatus of any one of examples 1-3, further including a memory to store one or more KV pairs, the memory accessible by the IC device and by the processing unit, in which the one or more KV pairs are generated by the IC device by executing the first DNN model, in which the processing unit generates the output of the second DNN model further based on the one or more KV pairs.
Example 5 provides the apparatus of any one of examples 1-4, further including a router to: select the IC device from a plurality of IC devices; and provide the input prompt to the IC device.
Example 6 provides the apparatus of example 5, in which different ones of the plurality of IC devices are specific to different DNN models that are trained for performing different types of tasks.
Example 7 provides the apparatus of example 5 or 6, in which the router is another integrated unit device that is to implement a model trained for routing input prompts to the plurality of IC devices.
Example 8 provides the apparatus of any one of examples 1-7, in which the output of the second DNN model includes a speculative token that is validated by the processing unit.
Example 9 provides the computing system of example 8, in which the output of the second DNN model further includes one or more tokens generated by the processing unit based on the speculative token.
Example 10 provides the apparatus of any one of examples 1-9, in which the IC device includes a dot unit to implement a matrix multiplication operator and an add operator in the first DNN model, the dot unit including one or more adders and one or more multipliers; and an activator unit to implement an activation function operator in the first DNN model.
Example 11 provides a computing system, including a plurality of IC devices, different ones of the plurality of IC devices specialized to implement different neural network models; a router to: select an IC device from the plurality of IC devices, and route an input prompt to the selected IC device, in which the selected IC device is to generate one or more speculative tokens from the input prompt; and a processing unit to: perform an evaluation on the one or more speculative tokens generated by the selected IC device, and generate an output based on a result of the evaluation.
Example 12 provides the computing system of example 11, in which performing the evaluation includes evaluating two or more speculative tokens in parallel.
Example 13 provides the computing system of example 12, in which the selected IC device is to generate the two or more speculative tokens sequentially.
Example 14 provides the computing system of any one of examples 11-13, further including a memory to store one or more key-value pairs generated by the selected IC device, in which the memory is accessible by the plurality of IC devices and by the processing unit.
Example 15 provides the computing system of example 14, in which the processing unit generates the output further based on the one or more KV pairs.
Example 16 provides the computing system of any one of examples 11-15, in which the different DNN models are trained for performing different types of tasks.
Example 17 provides the computing system of any one of examples 11-16, in which the router is another integrated unit device that is to implement a model trained for routing input prompts to the plurality of IC devices.
Example 18 provides the computing system of any one of examples 11-17, in which performing the evaluation includes determining whether an accuracy score or confidence score of each of the one or more speculative tokens is above a threshold score.
Example 19 provides the computing system of example 18, in which the output of the second neural network model includes a speculative token that is validated by the processing unit and one or more tokens generated by the processing unit based on the speculative token.
Example 20 provides the computing system of any one of examples 11-19, in which the selected IC device includes a dot unit to implement a matrix multiplication operator and an add operator in the first DNN model, the dot unit including one or more adders and one or more multipliers; and an activator unit to implement an activation function operator in the first DNN model.
Example 21 provides one or more non-transitory computer-readable media storing instructions executable to perform operations, the operations including routing an input prompt to an IC device selected from a plurality of IC devices, the IC device including hardware implementations of operators in a first DNN model; generating, by the IC device, one or more speculative tokens from the input prompt by running the operators in the first DNN model; evaluating, by a processing unit, validity of the one or more speculative tokens by executing a second DNN model; and generating, by the processing unit, an output of the second DNN model based on the validity of the one or more speculative tokens.
Example 22 provides the one or more non-transitory computer-readable media of example 21, in which the one or more speculative tokens includes a plurality of speculative tokens, in which evaluating the validity of the one or more speculative tokens includes evaluating validity of the plurality of speculative tokens in parallel.
Example 23 provides the one or more non-transitory computer-readable media of example 21 or 22, further including storing, in a memory, one or more KV pairs generated by the IC device by executing the first DNN model, in which the processing unit generates the output of the second DNN model further based on the one or more KV pairs.
Example 24 provides the one or more non-transitory computer-readable media of any one of examples 21-23, in which different ones of the plurality of IC devices are specific to different DNN models that are trained for performing different types of tasks.
Example 25 provides the one or more non-transitory computer-readable media of any one of examples 21-24, in which the output of the second DNN model includes a speculative token that is validated by the processing unit.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art can recognize. These modifications may be made to the disclosure in light of the above detailed description.

1. An apparatus, comprising:
an integrated circuit device specific to a first neural network model, the integrated circuit device comprising hardware implementations of operators in the first neural network model, wherein the integrated circuit device is to generate one or more speculative tokens from an input prompt by running the operators in the first neural network model; and
a processing unit to:
evaluate validity of the one or more speculative tokens by executing a second neural network model, and
generate an output of the second neural network model based on the validity of the one or more speculative tokens.

2. The apparatus of claim 1, wherein the one or more speculative tokens comprises a plurality of speculative tokens, wherein the processing unit is to evaluate validity of the plurality of speculative tokens in parallel.

3. The apparatus of claim 2, wherein the integrated circuit device is to generate the plurality of speculative tokens sequentially.

4. The apparatus of claim 1, further comprising:
a memory to store one or more key-value pairs, the memory accessible by the integrated circuit device and by the processing unit,
wherein the one or more key-value pairs are generated by the integrated circuit device by executing the first neural network model, wherein the processing unit generates the output of the second neural network model further based on the one or more key-value pairs.

5. The apparatus of claim 1, further comprising:
a router to:
select the integrated circuit device from a plurality of integrated circuit devices; and
provide the input prompt to the integrated circuit device.

6. The apparatus of claim 5, wherein different ones of the plurality of integrated circuit devices are specific to different neural network models that are trained for performing different types of tasks.

7. The apparatus of claim 5, wherein the router is another integrated unit device that is to implement a model trained for routing input prompts to the plurality of integrated circuit devices.

8. The apparatus of claim 1, wherein the output of the second neural network model comprises a speculative token that is validated by the processing unit.

9. The apparatus of claim 8, wherein the output of the second neural network model further comprises one or more tokens generated by the processing unit based on the speculative token.

10. The apparatus of claim 1, wherein the integrated circuit device comprises:
a dot unit to implement a matrix multiplication operator and an add operator in the first neural network model, the dot unit comprising one or more adders and one or more multipliers; and
an activator unit to implement an activation function operator in the first neural network model.

11. A computing system, comprising:
a plurality of integrated circuit devices, different ones of the plurality of integrated circuit devices specialized to implement different neural network models;
a router to:
select an integrated circuit device from the plurality of integrated circuit devices, and
route an input prompt to the selected integrated circuit device, wherein the selected integrated circuit device is to generate one or more speculative tokens from the input prompt; and
a processing unit to:
perform an evaluation on the one or more speculative tokens generated by the selected integrated circuit device, and
generate an output based on a result of the evaluation.

12. The computing system of claim 11, wherein performing the evaluation comprises evaluating two or more speculative tokens in parallel.

13. The computing system of claim 12, wherein the selected integrated circuit device is to generate the two or more speculative tokens sequentially.

14. The computing system of claim 11, further comprising:
a memory to store one or more key-value pairs generated by the selected integrated circuit device,
wherein the memory is accessible by the plurality of integrated circuit devices and by the processing unit.

15. The computing system of claim 14, wherein the processing unit generates the output further based on the one or more key-value pairs.

16. The computing system of claim 11, wherein the different neural network models are trained for performing different types of tasks.

17. The computing system of claim 11, wherein the router is another integrated unit device that is to implement a model trained for routing input prompts to the plurality of integrated circuit devices.

18. The computing system of claim 11, wherein performing the evaluation comprises determining whether an accuracy score or confidence score of each of the one or more speculative tokens is above a threshold score.

19. The computing system of claim 18, wherein the output of the second neural network model comprises a speculative token that is validated by the processing unit and one or more tokens generated by the processing unit based on the speculative token.

20. The computing system of claim 11, wherein the selected integrated circuit device comprises:
a dot unit to implement a matrix multiplication operator and an add operator in the first neural network model, the dot unit comprising one or more adders and one or more multipliers; and
an activator unit to implement an activation function operator in the first neural network model.

21. One or more non-transitory computer-readable media storing instructions executable to perform operations, the operations comprising:
routing an input prompt to an integrated circuit device selected from a plurality of integrated circuit devices, the integrated circuit device comprising hardware implementations of operators in a first neural network model;
generating, by the integrated circuit device, one or more speculative tokens from the input prompt by running the operators in the first neural network model;
evaluating, by a processing unit, validity of the one or more speculative tokens by executing a second neural network model; and
generating, by the processing unit, an output of the second neural network model based on the validity of the one or more speculative tokens.

22. The one or more non-transitory computer-readable media of claim 21, wherein the one or more speculative tokens comprises a plurality of speculative tokens, wherein evaluating the validity of the one or more speculative tokens comprises evaluating validity of the plurality of speculative tokens in parallel.

23. The one or more non-transitory computer-readable media of claim 21, further comprising:
storing, in a memory, one or more key-value pairs generated by the integrated circuit device by executing the first neural network model,
wherein the processing unit generates the output of the second neural network model further based on the one or more key-value pairs.

24. The one or more non-transitory computer-readable media of claim 21, wherein different ones of the plurality of integrated circuit devices are specific to different neural network models that are trained for performing different types of tasks.

25. The one or more non-transitory computer-readable media of claim 21, wherein the output of the second neural network model comprises a speculative token that is validated by the processing unit.
